(19) United States
(12) Patent Application Publication
(10) Pub. No.: US 2006/0074980 A1
(43) Pub. Date: Apr. 6, 2006

(54) System for semantically disambiguating text information

(75) Inventor: Devajyoti Sarkar, Tokyo (JP)

Correspondence Address: Alan H. MacPherson;MacPHERSON, KWOK CHEN & Heid LLP, Suite 226, 1762 Technology Drive, San Jose, CA, 95110, US

(73) Assignee: SARKAR PTE. LTD., Singapore (SG)

(21) Appl. No.: 10/954,964

(22) Filed: Sep. 29, 2004

(51) Int. Cl. G06F 17/00

(52) U.S. Cl. 707/104.1

(57) ABSTRACT

Disclosed is a semantic user interface system that allows text information to be tagged with machine-readable IDs that are associated with concepts for conveying information without any ambiguity or without being hampered by the limitations of human languages. Typically, a plurality of vocabularies are stored across a network, and each vocabulary includes a plurality of machine-readable IDs each corresponding to a concept and at least one keyword corresponding to each machine-readable ID. An input interface accepts text information, selects those machine-readable IDs whose keywords match up with the text information, and returns a list of candidates each corresponding to one of the selected machine-readable IDs and including a corresponding description. The machine-readable IDs can carry information in the form of concepts without any ambiguity as opposed to text information. This system can be applied to web and database searches, publishing messages to selected subscribers, interfacing of applications software, machine translations, etc.

### TECHNICAL FIELD

The present invention relates to a semantic user interface using a system for semantically disambiguating text information, and in particular to a system that allows text information to be tagged with machine-readable IDs that are associated with concepts for conveying information without any ambiguity or without being hampered by the limitations of human languages.

### BACKGROUND OF THE INVENTION

### BACKGROUND

The advent of the Internet has dramatically changed the way people search and find information. The Internet connects a large number of computers across diverse geography to provide access to a vast body of information. The most wide spread method of providing information over the Internet is via the World Wide Web. The Web consists of a subset of the computers or Web servers connected to the Internet that typically run Hypertext Transfer Protocol (HTTP). Web servers host Web pages at Web sites. Web pages are encoded using one or more languages, such as the original Hypertext Markup Language (HTML). A specific location of information on the Internet is designated by a Uniform Resource Locator (URL). A URL is a string expression that generally specifies the location of a server on the Internet, the directory on the server where specific files containing information are found, and the names of the specific files containing information.

The true success of the web lies in the fact that three simple standards—the URL, HTTP and HTML, allowed a truly distributed access to all of the information on the web. Any browser software such as Microsoft's Internet Explorer or Netscape's Navigator, could talk to any computer on the Internet that ran any web server software such as Apache or Microsoft IIS. Any one could write a web page in HTML that could be browsed by any browser. Furthermore, any web page could link to content from any other web page on the internet.

This “Open World” characteristic is a significant cause for the popularity of the web enables the knowledge worker to have a very large amount of information from all over the world at his/her fingertips. However, most of the content on the web is written for human consumption and is not readily understood by machines. Content in HTML allows a browser to parse it and know how to display it but it does not understand the meaning or the context of the content. Therefore, it is up to the person to understand whether it is relevant to his/her task or not. The next generation web called the Semantic Web, is targeting to address such issues.

The Semantic Web is an attempt at moving from a purely visual metaphor that the current web is based on and add on it a meaning layer that is machine-readable.

Essentially it will be a web of data, in some ways like a global database. The Semantic Web builds on top of the existing Web in layers. The layers are presented in FIG. 1. The Unicode layer is a standard for multiple language character sets and makes it possible to completely internationalize all data that is exchanged. The URI or Uniform Resource Identifier is a standard that allows anything to have a globally unique address. Unlike the URL standard, which is limited to files or file system resources, URI's can be used to describe anything including abstract concepts as well as physical objects in a fashion that a program can uniquely identify the described object.

XML is a meta language that allows to describe markup languages. HTML is a markup language that focuses on display. For example, the following snippet—<B><I>Web</I></B> specifies that the browser draw the word “Web” in a bold+italic font style. XML allows the capability where one can create a custom markup language in which one can write a snippet like <FIRSTNAME>Devajyoti</FIRSTNAME><LASTNAME>Sarkar</LASTNAME>. Here instead of specifying how to display Devajyoti Sarkar, this is specifying which is the first name and which is the last name. Unlike HTML where there is a standard meaning for the definition of the markup tags, XML allows anyone to create their own vocabulary of tags, as long as they are placed within a unique namespace so that the tags will not conflict with other markup languages that are created. Furthermore, the XML standards also include XML Schema that allows the definition of valid data values that tags can take. For example it is possible to limit the valid values of FIRSTNAME and LASTNAME to strings. The combination of these standards allow the creation of XML documents that can be parsed accurately by software and allows a rich data representation format that is open and facilitates interchange of documents between different applications. Microsoft's recent versions of their Office suite of applications supports saving files in XML format that allows multiple applications to read and process their data.

XML has had a phenomenal uptake in the commercial world where XML based Web Services and Service Oriented Architectures are on the way to be the major platform on which future systems will be built. However, XML has many limitations as a language for describing concepts. As an example, the tag <FIRSTNAME> in one XML schema may mean the same as <GIVENNAME> in another but there is no way for two applications to find that out if they do not know it in the first place. Essentially, in terms of semantics, the XML data format is fine if two applications agree to the same schema and have a prior agreement on the meanings of their elements. However, there is no way to specify that an element in one schema “means” the same thing as an element in another. There is also no concept of classes and properties. There is no concept of inheritance. A significant amount of functionality that is required to represent knowledge and describe data is missing.

RDF, RDF Schema and OWL have been built to provide these missing pieces. With RDF and RDFSchema it is possible to make statements about objects with URI's and define vocabularies that can be referred to by URI's. This is the layer where we can give types to resources and links. The Ontology layer supports the evolution of vocabularies as it can define relations between the different concepts. It is through ontologies that we have sufficient expressive power to express and share the semantics of a given concept. It is these standards that provide the semantics on top of XML. They have an XML based syntax with namespace and schema definitions that make sure that the Semantic Web definitions can be integrated with the other XML based standards. The Digital Signature layer is for detecting alterations to documents. The Logic layer enables the writing of rules while the Proof layer executes the rules and evaluates together with the Trust layer mechanism for applications whether to trust the given proof or not.

RDF is a datamodel for resources and relations between them, provides a simple semantics for this datamodel, and these datamodels can be represented in XML syntax. RDF Schema is a vocabulary for describing properties and classes of RDF resources, with semantics for generalization-hierarchies of such properties and classes. OWL adds more vocabulary for describing properties and classes: among others, relations between classes (e.g. disjointness), cardinality (e.g. “exactly one”), equality, richer typing of properties, characteristics of properties (e.g. symmetry), and enumerated classes. OWL provides three increasingly expressive sublanguages designed for use by specific communities of implementers and users. OWL Lite supports those users primarily needing a classification hierarchy and simple constraints. OWL DL supports those users who want the maximum expressiveness while retaining computational completeness (all conclusions are guaranteed to be computable) and decidability (all computations will finish in finite time). OWL Full is meant for users who want maximum expressiveness and the syntactic freedom of RDF with no computational guarantees. For example, in OWL Full a class can be treated simultaneously as a collection of individuals and as an individual in its own right. OWL Full allows an ontology to augment the meaning of the pre-defined (RDF or OWL) vocabulary. It is unlikely that any reasoning software will be able to support complete reasoning for every feature of OWL Full. RDF, RDF Schema and OWL are now W3C Recommendations. A detailed description of this is available at http://www.w3.org/2001/sw/.

One question that comes up when describing yet another XML/Web standard is “What does this buy me that XML and XML Schema don't?” An operational consensus can always be developed over the meaning of a set of XML tags and their contents. There is large amount of ongoing standards activity doing exactly this.

There are two answers to this question.
1. An ontology differs from an XML schema in that it is a knowledge representation, not a message format. Most industry based web standards consist of a combination of message formats and protocol specifications. These formats have been given an operational semantics. “Upon receipt of this PurchaseOrder message, transfer Amount dollars from AccountFrom to AccountTo and ship Product.” But the specification is not designed to support reasoning outside the transaction context. For example, we won't in general have a mechanism to conclude that because the Product is a type of Chardonnay it must also be a white wine.
2. One advantage of OWL ontologies will be the availability of tools that can reason about them. They will provide generic support that is not specific to the particular subject domain, which would be the case if one were to build a system to reason about a specific industry-standard XML schema. Building a sound and useful reasoning system is not a simple effort. Constructing an ontology is much more tractable. It is expected that many groups will embark on ontology construction. They will benefit from third party tools based on the formal properties of the OWL language, tools that will deliver an assortment of capabilities that most organizations would be hard pressed to duplicate.

Ontologies are a key enabling technology for the semantic web. They interweave human understanding of symbols with their machine processability. Ontologies were developed in Artificial Intelligence to facilitate knowledge sharing and re-use. Since the early nineties, Ontologies have become a popular research topic. They have been studied by several Artificial Intelligence research communities, including Knowledge Engineering, natural-language processing and knowledge representation.

More recently, the concept of Ontology is also becoming widespread in fields, such as intelligent information integration, cooperative information systems, information retrieval, electronic commerce, and knowledge management. The reason that ontologies are becoming so popular is largely due to what they promise: a shared and common understanding of a domain that can be communicated between people and application systems. In a nutshell, Ontologies are formal and consensual specifications of conceptualizations that provide a shared and common understanding of a domain, an understanding that can be communicated across people and application systems. Thus, Ontologies glue together two essential aspects that help to bring the web to its full potential:
Ontologies define formal semantics for information, consequently allowing information processing by a computer.
Ontologies define real-world semantics, which makes it possible to link machine processable content with meaning for humans based on consensual terminologies.

The Semantic Web is conceptually a significant step forward. It has applications in a wide range of uses such Enterprise Application Integration, superior searches, conversion of static text documents into information repositories that can be processed by applications and many others. However, the Semantic Web has yet to find successful implementation that lives up to its stated potential. This in many ways can be linked to the fact that it does not have a clear User Interface paradigm that allows the user to specify meaning in such a way that the computer can understand it. In the case of the current web, it was the development of the browser that fueled the growth in uses that the original creators of the web could hardly have imagined. Essentially, it was the killer app that drove the adoption of the standards and primarily because it made the average user the consumer of all web content. While the Semantic Web is fundamentally targeted at enabling machines to participate in context generation, a paradigm that brings the end-user into the equation will be a key requirement for the adoption of these technologies in a wide and distributed fashion. In fact, the W3C has been holding the Semantic Web Challenge whose purpose, among other things, is to be able to articulate an interface that will allow someone to explain the semantic web to their grandparents. As of yet there is no paradigm that enables an intuitive and practical way for the user to participate in this process. There have been a number of attempts at creating user interfaces based on meaning. The section below covers information about such attempts.

Previous Attempts at Semantic User Interfaces

There are have been several attempts at creating a user interface at the semantic level. Perhaps the most significant attempt to date at making a user interface for the Semantic Web has been undertaken by the Haystack project at MIT. In their paper “How to Make a Semantic Web Browser”, Dennis Quan and David Karger (presented at WWW2004) describe the details of Haystack's approach to making an intuitive front-end to the semantic web. The authors note that the rapid, organic growth of the Web was due in large part to the ubiquity of the Web browser—a universal client that provides immediate access to new content as soon as it comes online. Such a situation encourages numerous individuals to produce content, in the knowledge that there will be easy access to it. Similarly, in their opinion, the existence of a good Semantic Web browser may also speed the proliferation of the Semantic Web.

Haystack is an end user application that automatically locates metadata and assembles point-and-click interfaces from a combination of relevant information, ontological specifications, and presentation knowledge, all described in RDF and retrieved dynamically from the Semantic Web. The information view is rendered through using “lenses”. A lens is defined to be a list of properties that make sense being shown together. The reason for defining lenses is that there could potentially be an infinite number of predicate/object pairs characterizing a resource; lenses help filter the information being presented to the user. Lenses are shown as panels that display some fragment of information about a resource. Haystack's presentation of the information is controlled by presentation “recommendations”. As the authors note, unlike the web where all information about a web page is present at the authoritative server of the page, the semantic web allows parties other than the authoritative server to provide statements about resources, and these metadata residing on separate servers need to be accessible to the user. Thus, unlike the ‘dumb terminal’ like web browser, the semantic web browser needs to be intelligent enough to merge separate pieces of information about a single resource from several different Web sites. This allows user driven content aggregation without requiring specialized portal sites and being personalized as per user requirements. Furthermore, the separation of content from presentation means lowers the bar to publishing, since individuals can now produce “unformatted” semantic information, relying on end user clients to figure out good ways to present it.

The authors also note that a large part of the Web consists of form-driven services that let users submit requests to Web servers. As with content, the Semantic Web can also play a role in improving direct human interaction with services. When services are marked up with semantics, interfaces can be built that help individuals locate the appropriate services to invoke for a given task, that help users fill in the necessary arguments to the services, and that support naïve-user customization of the services for the users' own purposes. Haystack evolves the concept that semantically marked up data at the user interface can be dynamically associated with web services (called “Operations”) through menu commands. The data is matched against the parameters required for different services and a context menu listing the different services applicable to the data type is shown. If the service requires further information, parameters for such calls can be filled through constructing lenses for the appropriate parameter type required. For example, the “email link” operation might be configured to accept one parameter of any type (the resource to send) and another that must have type Identity (e.g., a person or an e-mail agent).

Haystack is an innovative example of the various possibilities that the Semantic Web creates. It provides seamless implementation of a number of services required to make the Semantic Web accessible to users. Yet it is still, for the most part, focused on the viewing of semantically enabled data. The primary metaphor of user interaction with the machine representation of meaning comes through its concept of Operations in the context menu associated with semantically marked up data and through the drag-and-drop of such data. It allows the user to easily move information objects between applications or to discover functions that can be invoked on it. Essentially, giving the user that feeling that the information belongs to the user instead of the application. But it does not allow the user to specify the information in the first place. This is due to the fact that it does not provide any mechanism that allows the user communicate semantic concepts to the application in an intuitive manner. The lack of such a mechanism means that the user is restricted to the data that Haystack automatically marks up and essentially makes for a one-way communication paradigm with user in terms of semantics.

Other attempts at bridging the gap between the user and the Semantic Web (such as SEAL and Semantic Search) use the concept of a semantic portal. However, in this case, it is the administrator who aggregates semantically classified information in a centralized location for dissemination to users. Because these portals often use Web servers to distribute their information, server side HTML templates are typically employed to convert metadata into a human-readable presentation. The semantic portal approach has the advantage of maintainability, since all of the presentation logic and choice of data sources are configured in one central location. Furthermore, users of the existing Web can consume Semantic Web information; end users gain access to important metadata without needing to be aware that RDF is involved. Unfortunately, the dynamic, ad hoc nature of the Web—anyone being able to author a piece of information that is immediately available to everyone—is thus buried within ostensibly monolithic aggregations under centralized control. It is unlikely, if not undesirable, to have such a mechanism represent Human Computer Interface at a semantic level.

Other systems exist for visualizing metadata that take the form of end-user applications. These systems commonly employ automatic form generation techniques seen in desktop database applications; a good example is Protege [30], an ontology editor. Commercial products like XMLSpy perform a similar function for XML and XML Schema.

However, this approach is primarily to serve as tools for a specialist and will be too difficult for an ordinary user to learn.

Other applications take another approach to visualization that is inspired by the notion of the Semantic Web being an extension of the existing Web. Systems such as Magpie augment standard Web browsers with the ability to act on resources described in Web pages and to find resources semantically related to a Web page. Tools such as Annotea allow users to embed and read RDF-encoded textual annotations in Web pages from a Web browser. However, all these examples are applications that create some functionality but do not address the broader problem of the user interface.

Microsoft made an initial attempt at providing an implementation of semantics through the Smart Tag concept introduced in recent versions of their Office product. While this implemented context menu based actions similar to the Haystack model, it suffered from a further problem where the semantic markup of the data was performed by recognizers operating independently from the author of the data. As the author typed in a document or if a document was opened, a recognizer module parsed the text and if it recognized certain words, the module would markup the text with the meaning it understands. This is unreliable as often the recognizer would markup the words with a meaning different from the intended one of the author. Again, it does not provide the ability to the author to explicitly provide semantic context of the data and therefore quite often, the data is marked different from the author's intention.

An area of research that has actively investigated human communication with systems at the level of meaning is Natural Language Processing. More specifically, NLP-enhanced Information Storage and Retrieval has given a number of paradigms for man-machine interface at the level of meaning. Some of the major inventions are listed below:

In U.S. Pat. No. 6,026,388, Liddy et al. describe a Natural Language processing based user interface to querying and indexing of documents. The user enters a query and the system processes the query to generate an alternative representation, which includes conceptual-level abstraction and representations based on complex nominals (CNs), proper nouns (PNs), single terms, text structure, and logical make-up of the query, including mandatory terms. After processing the query, the system displays query information to the user, indicating the system's interpretation and representation of the content of the query. The user is then given an opportunity to provide input, in response to which the system modifies the alternative representation of the query. The specific inputs that the user is allowed to choose from are options posed based Proper nouns, Complex Nominals and some other structured fields like Subject Field Codes, Request Preference and Time Frame. The essential mechanism of the semantic conversion of the entered text is through NLP which is not 100% reliable. The user is not given a chance to participate in the definition of this meaning through the user interface and therefore may not have the chance to correct inadequacies in the natural language parsing of the query.

In U.S. Pat. No. 6,446,081, Preston describes a user interface that allows the user to resolve lexical ambiguity in a natural language parsing of a sentence through the use of a graphical representation. A given text is first parsed in conjunction with a lexical database along with grammar rules and other NLP techniques. The machine understanding is then drawn in graph form to allow the user to review and correct the machine understanding if required. While this is an approach that includes the user in the natural language processing of input text, it suffers from the fact that it is cumbersome as an input method and may not be practical for the day to day processing needs of an average end user.

In U.S. Pat. No. 6,704,739, Craft, et al. describe a system that allows for the storage and retrieval of document assets tagged in a separate tag database. The tag database implements a semantic network of tags which corresponds to named concepts in a vein similar to the Semantic Web. These tags can be used in categorizing and characterizing data assets. These tags are used during the storage and retrieval of such data assets. This mechanism embodies the full richness of semantic representation including relationships, ontologies and rules governing tags. However it has many limitations. Firstly, while it may be independent of applications it is still limited to the saving and opening of files. It does not provide mechanisms to address a more generic domain. Furthermore, the tag database is implemented in a “Closed-World” model which does not provide the mechanism of ontology integration and management that would be required in an ‘Open-World’ model. Furthermore, it does not specify in any detail the user interface to the system apart from mentioning to use of standard GUI elements. This may not scale to a rich and large vocabulary that would be required of a generic implementation.

In U.S. Pat. No. 6,714,939, Saldanha, et al. describe a mechanism that can parse a text entered in a natural language into structured parametric data, both for purposes of content synthesis and for purposes of data retrieval. A content engine takes in a natural language sentence and produces a program component tree. The component tree is then further simplified before it is passed to a program for execution. Words in a sentence act as identifiers for components and an English sentence is transformed into a set of software objects The objects of the application domain are captured by using the Natural Markup Language (“NML”). This captures the domain specific words and maps them into concepts. It is interesting to note that the authors recognize that understanding natural language is neither required nor desired in generating structured data; rather, what is desired is the ability to map natural language onto program structure. While this approach can, in theory, be extensible to arbitrary domains by using different NML, it does suffer from some key limitations. There is really no way of knowing whether the representation created by this method is what the user really intends it to be. It is further limited by the ability of the NML to adequately represent the domain that both the developer and the user need to operate in. Furthermore, while such ambiguity may be tolerable in an internet search, the level of exactness that would be required in a semantic file system where a mistake may result in the user losing data would not permit such loose coupling.

In the MIT system START, the author Katz tries to create a question answering system that can operate in a natural language. Data resources from the web are annotated in a natural language with respect to questions that can possibly be asked against it. Queries are also entered in a natural language. Both these are parsed in T-expressions which are used for matching and retrieval of information. This allows the system to take a query like “What is the GNP of India” and return the precise answer. While, there are aspects of this that are similar to the Semantic Web, however, the user interface is limited and serves a restricted domain.

Metalog is project within the W3C to create a pseudo-natural language reasoning system for the Semantic Web. The main language that Metalog uses to communicate (PNL) seems very similar to natural language. PNL stands for Pseudo Natural Language, and means that it is similar to natural language, but a very simplified one. Metalog's PNL interface is totally unambiguous, and it does so by limiting considerably the sentences that can be written in it. However, the expressive capability of the language is severely restricted in its current form and not easily amenable to practical use.

### SUMMARY OF THE INVENTION

The Resource Description Framework (RDF) is a language for representing information about resources in the World Wide Web. It is particularly intended for representing metadata, such as the title, author, and modification date of a Web page, etc. RDF is based on the idea of identifying things using Web identifiers (called Uniform Resource Identifiers, or URIs), and describing resources in terms of simple properties and property values. This is done through using triples in the form of subject-predicate-object. Using the example of a fictitious person John Doe in a fictitious organization called example.org, we can write the statements like the following:

http://example.org/People/JohnDoe http://example.org/terms/name “John Doe”

http://example.org/People/JohnDoe http://example.org/terms/email “john.doe@example.org”

http://example.org/People/JohnDoe http://example.org/terms/reportsTo

http://example.org/People/RichardRoe

This is graphically represented in FIG. 2.

The subject and the predicate are given by URIs, which are a globally unique ID for them. The object can have data values like strings or refer to other concepts given by URIs. This enables RDF to represent simple statements about resources as a directed labeled graph of nodes and arcs representing the resources, and their properties and values. Thus, any concept or object is identified with a URI as well as the properties for such URIs are also described by URIs. Essentially, the URI serves as a globally unique, machine-readable name for the concepts that they embody.

RDF Schema provides a simple but expressive language for the definition of classes, objects and properties. The OWL languages that allow the definition of more sophisticated ontologies of such concepts and resources further enhance the abilities of RDF Schema. These then form the basis of knowledge representation upon which rules and reasoning engines can function.

The current web is based on a document paradigm. Therefore, the most appropriate user interface to it is a software that allows a user to browse it. The Semantic web is based on knowledge representation. While it is primarily targeted at software agents to allow them to run inferences on it, there is still a major need for an end-user interface to it. As the name states, a user interface for the Semantic Web must operate at the level of meaning.

The viewing of semantic data in RDF is a simpler task where each resource and property can be described on the screen through human readable labels. For example, the representation above can be displayed as shown in FIG. 3.

Haystack provides an implementation where an RDF document is rendered on the basis of the type of the statement. For example, above, the Reports to: field is rendered as the full name of the person referred to by the URI instead of the URI itself. However, it is a much more difficult problem to create a user interface that allows the user to specify their intended meaning in the form of RDF that the system recognizes. While this can be done trivially if the user can write in RDF, RDFS and OWL, but this is no small task for programmers let alone average users. Essentially, while these languages provide constructs to create a machine-readable document, they are neither ‘human-readable’ or ‘human-writable’ for an ordinary end user.

The most significant attempt at creating a user interface operating at the level of human meaning is Natural Language Processing. This allows a user to enter sentences in a natural language and the systems attempts to understand the meaning conveyed by it. The best state of art in this in unreliable. This is due to the fact that humans derive meaning from context, a shared world understanding and experience. A sentence that may be simple for an ordinary person to understand is very difficult for a computer system. It is believed that attaining such comprehension will need a system to be AI-complete. This is a goal that is not considered practical at the current moment. Thus using NLP to serve as the user interface to RDF, RDFS and OWL is unreliable and intractable.

NLP is neither required nor necessarily desirable to allow the user to specify a concept to the system. Most of the resource description contained in the ontologies stored in RDF refer to concepts the user already has an intuitive understanding about. RDF document describing a book is encoding information about the book that the user already can understand. A user knows what a book is, that it has an author, that it has a publisher, that it is written in a certain language, etc. All that is required is for the user to specify a concept in a natural and intuitive manner and have that concept mapped unambiguously to the equivalent URI used in the ontology. Since classes, individuals (objects) and properties are all specified by URIs, all of these can be mapped in a similar fashion.

In a certain sense, in natural language communication we use words to denote concepts.

We know that a ‘rose’ is red, has thorns, and serves as a good gift. In communication, when we use the word rose, the listener understands the concept of a rose without the speaker having to explain it to him. Each person may have a different level of understanding or knowledge with regards to the concept ‘rose’ but they share a common set of knowledge and experience that allows the word to denote something meaningful that can facilitate communication between them. Depending on the requirements of the conversation, the speaker may need to elaborate and explain characteristics of a concept to someone who may not know them, in order to fully communicate. As an example, a botanist will know much more about a rose than a layman, and if the botanist wishes to communicate something about roses that a layman does not understand he will need to describe the concept in more detail so that the listener can comprehend. However, for commonly used concepts, a significant function is served just by having a word that names it.

In a similar vein, in the Enterprise Application Integration, different systems need to communicate with each other to process functionality. For example, a procurement system will need to communicate with an inventory system to judge whether there is a need to order more parts. In order for such communication to take place, they have to agree on a data model where they have a common reference to a given part. Typically this is done through data base tables where a unique key for a part in one system is mapped to a unique key for the same part in the other system. Each system may have different amounts of data on the part and may perform different functions with the part, but the minimum requirement for communication is the agreement of a common ‘name’ for the part.

In the case of the semantic web, the URI serves as a unique ‘name’ to a concept. Different ontologies can store different amounts of knowledge representation regarding the concept but as long they share a common URI or have URIs that can be mapped to each other, they can share knowledge regarding the concept. If the concept is one that a user can understand (which can quite often be the case), the machine and user need to be able to map a word that the user uses to describe the concept to a URI that the machine uses to describe the concept. It does not matter whether the user has a better understanding of the concept or the machine does, as long as there is sufficient overlap for the functionality intended, such a mapping will suffice to communicate to the system the concept that the user has in mind. All that a user interface needs to do is to provide a mapping between natural language words that a person uses to describe a concept to the URI that that machine uses to reference the description of that concept.

Such a mechanism can serve a broad range of functions. As an example, if the user can specify to the application that a given object is a book, then the UI (like Haystack) can automatically present a number of dialog windows with forms for properties and values that allow the user to fill relevant details like author, language, etc. Such details on the book object can be expected to be in the corresponding ontology for books in the machine. Filling up the form of property and values is trivial for data properties that expect values like strings, numbers, etc. For property values that expect objects, the same user interface is used for specifying the concept and having it mapped to a URI. The same is applicable to property names.

However, mapping user-entered text to the intended meaning of the user is not a trivial task. Each word can have several meanings and a given meaning may be described by several words or phrases. This is due to lexical ambiguity of natural languages. It may, however, be possible to create a system that allows the user to select their intended meaning from a list of meanings that the system thinks is relevant and have user disambiguate the meaning. All that is required is to present a context menu that allows the user to easily distinguish between the choices. The requirements for this are much more modest than the requirement of AI completeness in a method such as NLP.

The WordNet project in Princeton has been an attempt at researching the lexical nature of human memory. It attempts to create a lexical dictionary based on word-meanings (meaning derived by humans) instead of word-forms (the actual word used). It recognizes that there is a many-to-many relationship between word forms and word meanings. A given word-form like “room” can have many meanings that humans derive from the context of its use. Similarly, a meaning for the word “room” can denote space and can also be described a number of synonyms that are different word-forms. Meanings are defined in WordNet on the basis of synsets. Essentially, word-meanings that can be formed as a set of synonym word-forms and are considered a concept. The creators of WordNet note that how lexical concepts are represented in a theory of lexical semantics depends on whether the theory is intended to be constructive or differential. In a constructive theory, the representation should contain sufficient information to support an accurate construction of the concept (by either a person or a machine). The requirements of a constructive theory are not easily met, and there is some reason to believe that the definitions found in most standard dictionaries do not meet them. In a differential theory, on the other hand, meanings can be represented by any symbols that enable a theorist to distinguish among them. The requirements for a differential theory are more modest, yet suffice for the construction of the desired mappings. If the person who reads the definition has already acquired the concept and needs merely to identify it, then a synonym (or near synonym) is often sufficient. For example, someone who knows that board can signify either a piece of lumber or a group of people assembled for some purpose will be able to pick out the intended sense with no more help than plank or committee. Since a natural language is typically rich in synonyms, synsets are often sufficient for differential purposes. Sometimes, however, an appropriate synonym is not available, in which case the polysemy can be resolved by a short glossary entry or gloss, e.g., {board, (a person's meals, provided regularly for money)} car serve to differentiate this sense of board from the others; it can be regarded as a synset with a single member.

Synsets in WordNet can have multiple semantic relationships between them. These include synonymy, antonymy, hyponymy, meronymy and others. WordNet notes that nouns typically can be represented in terms of hyponymy/hypernymy into a lexical inheritance hierarchy. Nouns derive meaning from a super-ordinate term plus distinguishing features. For example, a ‘canary’ is a ‘bird’. If the meaning of bird is known (such as has wings, flies), then a canary can be described in terms of its distinguishing features such as ‘small’, ‘yellow’, ‘sings’, etc. While the question of whether human memory is truly organized in such a lexical fashion is still undecided, it is a useful method over a broad range of functions and used in computer systems as well in object oriented programming and ontologies. WordNet itself is based on such a premise.

These principles can be applied to the construction of a User Interface for semantic concepts as well. Essentially, semantic concepts in an ontology given by URIs can be represented by human readable words in synsets much like the case of word-meanings in WordNet. Essentially, a given concept may be described by a number of different words or phrases in text. Also, a given word can be mapped into multiple concepts given by their URIs. In the case of ontologies, it is likely that there will exist a large number of ontologies that a user interface will need to cater to. The RDF and ontologies used in applications can be expected to be specialized for the purposes of the application. There are a number of ontologies that have been created by the Knowledge Representation and Natural Language research communities. There are a number of major ontologies already available such as the Cyc project of Cycorp, Mikrokosmos, Pennman Upper Model, SENSUS and others. Therefore, it quite likely that the same concept will be described in a number of different ontologies, each providing further description. Therefore, a given word may be mapped not only to multiple concepts but also to multiple representations of the same concept as given by their ontologies. Another major difference is that effort in ontologies is to create descriptions of the world for a specific purpose. It is unlikely that all the meanings used within a natural language dictionary like WordNet will be required in a given application or the applications that a user uses. Many important words like Proper Nouns, co-locations, domain specific vocabularies are not included in a traditional dictionary. Furthermore, ontologies have semantic relationships, clearly defined structures and properties for classes and objects that are not normally covered in a dictionary. Also, concepts used in one classification terminology can have subtly different meanings from the same concepts used in another classification. Thus following the user interface concept of WordNet or other such ontologies alone will not suffice as a generic user interface for applications. However, the basic method of having the user being able to distinguish the meaning of a concept using close synonyms or description text remains valid as long as the context is clearly specified and user is familiar with the concept.

Basic Description

The core ability of this invention is to map a user entered string into the semantic equivalent in a machine representation of meaning. Such a machine representation of meaning will contain at least a machine-readable ID (such as a URI) for the concept and can also be described further by properties through technologies such as RDF. Essentially this means the mapping of the user's desired meaning to the machine-readable ID of the equivalent concept as stored in an ontology. The invention presents a user interface that mediates between an application and an ontology such that the input text is converted to RDF markup based on the ontology. The application receives the semantically marked up data and can process it in an unambiguous manner.

As a naïve example to show what this means, let us take a small portion of the Amazon.com book hierarchy as shown in FIG. 4. Books are categorized according to subjects, function and other parameters. Each book has a number of parameters like the ISBN number that characterize the book. As can be seen, the hierarchy is itself a blend of ontologies. For example, the category ‘History’ under ‘Mathematics’ is not really a type of mathematics but a category regarding mathematical history. Nor is Science a type of book but a category for books. Amazon.com arranges these hierarchies because they are easiest for a browser of books to find what they want. However, this practice makes this very hierarchy specific to Amazon.com and makes it very difficult for third party developers using Amazon's web services API (Application Programming Interface). Amazon.com has offered and encouraged the use of their API with the goal of increasing the access to their books from other web sites and application developers. Their taxonomy, however, makes any software more difficult to write, maintain and such software breaks easily when the taxonomy changes to take into account changes in consumer behavior.

This can be considerably aided with ontologies and semantically enhanced applications. By having separate taxonomies based on categories and a well-defined ontology, a book on mathematical history could be tagged as having subject categories ‘mathematics’ and ‘history’. Furthermore, each category can be given a machine readable URI so that there is no confusion between ‘Applied’ in the ‘Mathematics’ hierarchy and ‘Applied’ in the ‘Psychology’ hierarchy. Furthermore, there can be a generally accepted notion of what a book is and the different categories described here. In that sense Amazon.com can leverage a standardized ontology for both these purposes and define only the terms that they need which are not covered in a generally accepted ontology. By working with these, third-party developers will be able to create software that works with Amazon.com in a simpler and more reliable manner than what currently exists while leaving Amazon.com flexibility in changing their taxonomy.

Given a scenario like the one described above, it is possible to build software with very general functionality. Let us say there is a search software allows a user to search across the web. A user can type in ‘book’ into the search window. Once the user has finished typing, the user interface described in this invention can take the string ‘book’ and match it against concepts that are stored in its ontology and find matches to it as shown in the FIG. 5:

Once the user selects the meaning ‘Book: A written work or composition”, the user interface can covert it into the URI describing the concept ‘book’ stored within its ontology and pass it to the application. The application can query the ontology store and understand that a book can have multiple characteristics. It can present a dialog window as shown in FIG. 6 that allows the user to specify further information regarding the book as shown below. The user can then fill in categories such as ‘Applied Mathematics’ and ‘History’ in a manner similar to the one shown for selecting ‘Book’. Once this is done, the application can now unambiguously know that the query concerns books on Applied Mathematics history and can query Amazon.com and other service providers based on the parameters passed to it by the user interface in RDF. Since, the semantics are clearly defined, Amazon.com will be able to return the relevant results to the software. While this is a purely hypothetical example to show the functionality that the user interface described in this invention, it is important to note that a considerable amount of complexity that would otherwise have to be handcrafted in software is encapsulated in the data structure allowing the application to work on a more abstract plane. This search software can easily extend this to deal with other objects like CDs, DVDs, etc. Similarly, many other software and services can provide similar functionality as the requirements for software development have been considerably lowered. A key component of achieving such a generalization is to have an ontology store with a generic user interface that covers the normal requirements of an end-user in an open, application independent fashion.

The present invention is focused on providing a user interface that allows the user to pick a semantic meaning that is represented in a pre-existing ontology that corresponds best to his/her intent and communicate the semantically marked up text representation of that meaning to an application. It consists of a user interface and an ontology engine.

In FIG. 7, The User Interface (7-1) may take the form of a Graphical User Interface (GUI) in normal usage. Essentially, a user enters the word or words that correspond to what the user wishes to convey. Once the entry is complete, the user indicates to the system that the input is finished. This may be done through the use of a special key sequence as is common in Input methods for East Asian languages such as Japanese or Chinese. The system takes the text string of the input and searches the ontology engine for concepts that match the users input. Essentially each concept stored in the ontology engine is associated with keywords. Each keyword can consist of one or many words, phrases, sentences, etc. Zero or more concepts can have keywords corresponding to the input text. If the ontology engine finds one or more such concepts, it presents them as a list of candidates. As shown in FIG. 5, the user may input text in the application area (5-2) and indicate to the system that the ontology engine can now process the input. The ontology engine matches the input text against concepts and presents a dialog GUI that shows the relevant candidates as shown in (5-3). The GUI dialog may have three panels; the central panel represents the different concepts associated with the entered text. The concepts listed may come from multiple separate ontologies (called vocabularies) stored in the ontology engine as indicated in the extreme left side of the screen as shown in 5-1. The central panel lists the concepts that share the same keywords (5-6). A cursor is positioned on the top candidate where the sort order of candidates may be determined by the frequency of association of the keyword with the concept. That is to say that the concept most commonly associated with the given keyword is positioned at the top of the list. Furthermore, each concept may have a higher or lower level concepts structured as per the vocabulary associated with the concept. In FIG. 5, 5-5 refers to the current candidate selection as shown by the cursor. 5-4 shows the parent concept of 5-5. 5-7 shows the child concepts of 5-5. The user may use arrow keys to scroll a cursor down to the meaning that is closest to what the user intends. The user can also use the left or right arrow key to traverse the hierarchy of concepts to determine the best fit for his intended purpose. Once the user has determined the concept that he/she wants, they can enter a key sequence that indicates to the system that this is their desired meaning. The system then takes the entered text and semantically marks it up with the specified concept as represented by its machine-readable ID. Semantically marking up text may be done in the form of creating a set of RDF statements that associate the URI that defines the concept with the corresponding text. Once this is complete, the system transfers the semantically marked up text to the application for further processing. While it is expected that most of the text-to-concept conversion will occur one concept at a time, this same method may be extended to working with multiple concepts or sentences in manner similar to that currently used with Input Methods used for East Asian languages.

The ontology engine stores a plurality of concepts, each of which corresponds to a machine representation of meaning and is given an ID such as a URI. These concepts are organized on the basis of ontologies that are called vocabularies. The ontology engine can store a plurality of such vocabularies. Each vocabulary can be developed independent of each other by artibtrary parties. Each vocabulary may contain zero or more concepts. Each concept needs to have at least one and possibly a plurality of properties called keywords all of which are text strings. These keywords may be words, phrases or sentences. These keywords may be grouped by locale such as language allowing the interface to operate in a similar manner over a number of natural languages.

This may be done through using metadata such as the language attribute ‘xml:lang’ of the RDF literal. Each concept may further be described by a special text string called description that describes the concept in a natural language sentence. Like keywords, such descriptions may exist in a number of languages and tagged with its corresponding language. The ontology defines one relationship in the form of a parent-child relationship between concepts called a narrower-Concept relationship. The relationship goes from the child to the parent. The concepts represented as nodes and the narrower-Concept relationships represented as edges form a Directed Acyclic Graph (or DAG). The narrower-Concept relationship is transitive. This means that if A is ‘narrower-Concept’ than B and B is ‘narrower-Concept’ than C, then A is ‘narrower-Concept’ than C. Concepts within vocabularies are mapped across the vocabularies using the narrower-Concept relationship as well as a relationship called exact-match that corresponds to concepts across vocabularies that exactly equivalent in their meaning. This is illustrated in FIG. 8.

Each concept can have a much richer ontological representation with semantic relations with other concepts. The concept structure above is to index the classes or individuals in a broader ontology to the user interface component. Applications that a user uses will have a number of ontologies that are used that do not have any need to be exposed to the user. These do not require any purposing for the user interface. Only the classes, individuals, and properties that need to be exposed to the user require an entry in a vocabulary. Each concept in the vocabulary can be linked to the main definition of the class represented by the concept entry through an annotation property like rdfs:seeAlso or other methods. Thus an application that receives a concept marked up in RDF, can query the link to get the complete class definition through that link.

The requirements for a vocabulary to be added to the ontology engine for the user interface is quite minimal. Each concept that the ontology designer wishes to expose to the user interface must have keywords that a user uses to identify it and that such concepts are arranged in a hierarchy. However, given the open-world nature of RDF and ontologies, there are number of design decisions that must be taken based on the requirements of applications. Due to the fact that using classes as property values can affect whether the ontology is OWL DL compliant or not, the rest of this discussion describes a structure that retains DL compatibility. However, as people skilled in the art will note, the same may be implemented in a number of other ways representing compatibility with OWL Full, RDFS as well as representation that is independent of the Semantic Web technologies without diverging from the basic intent of the invention.

The SKOS ontology proposed by SWAD-Europe may be used to implement the above as well. The present invention shares a number of similarities with efforts in lexical dictionaries and thesaurus mapping projects. It is natural for any user interface for the Semantic Web will share a number of concepts with such ontologies. Users will be accessing concepts on the basis of names from natural language and from common usage (essentially terms of folk use that are used for categorization such as the book example in the previous section). There are, however, salient differences between the user interface of this invention and thesaurus efforts. This interface is meant to cover all the concepts that are used by a normal end-user. Thesaurus efforts focus on language and linguistics and identify many meanings or concepts that will not be used in a normal application and therefore are not needed in the user interface. However, this is not just a subset of an existing thesaurus. The ontologies used for this invention need to include objects (called individuals in RDF terminologies) and not just classes (as is the case with common nouns). Examples of this can include people stored in a contacts application (as a case in point, people can be referred to by their names, email addresses, nicknames much as a concept in the ontology is stored with separate keywords for the same concept and therefore handled cleanly in the interface like any other concept). There will also be the requirement for terminology that is specific to an organization that the user works in as well as domain specialized terms reflecting the specialization of the user. Also, a significant amount of functionality will come from rich semantic networks of relationships and knowledge representation that would not be included in a thesaurus based effort. Therefore, in order to implement this interface, the ontology engine needs to be an open-world system that allows vocabularies from different domains to be added seamlessly into the user interface.

The primary interface that the ontology engine presents to the user interface is to accept a keyword as a text string, and returns the corresponding concepts that store such a string as their keyword. All concepts exist within a vocabulary. It is likely that the ontology engine will store at least one such vocabulary and that it will come default with it. However, the ontology engine implements an open world behavior by having the ability to include arbitrary vocabularies through a process called mounting. Mounting allows the vocabulary to be merged with the existing graph in the ontology engine. Unmounting is the reverse process where a mounted vocabulary is removed from the ontology engine. These vocabularies will naturally be based on the concepts that the user needs to express in normal usage. Therefore, it is likely that the initial vocabulary will include common concepts with other vocabularies bringing in specific domain definitions. Vocabularies mounted in the ontology engine may further be upgraded and downgraded. Essentially, each vocabulary mounted in the ontology engine is stored along with its version identifier. During an upgrade of a vocabulary, the changes of the new version are incorporated into the existing vocabulary and the version number is changed to the new version number. During a downgrade of a vocabulary, the process follows in the reverse fashion of upgrading and the changes of the new vocabulary are removed and the version number brought down to the previous version.

The ontology engine maintains an index between keywords and concepts that they are used in. As shown in FIG. 7, it can be implemented as a local store or be distributed across a network. Such a distribution may be accomplished by using a number of well-known methods like client-server, master-slave, master-cache and peer-to-peer. In a client-server architecture, the vocabularies of the ontology engine may be stored on a network server and queried from the user interface. Such an approach has benefits in a limited capability client such as a cell-phone. In a master-cache architecture, client stores a subset of the total number of concepts available to a vocabulary. If the keyword matching does not find a suitable match, the query is sent to a master server on the network. Naturally, in a fashion similar to DNS servers, there may be multiple layers of servers, each serving as a caching server, before the request reaches the authoritative master server. In a master-slave architecture, updates are sent from the master to the slave such that progression of change information is one-way. In peer-to-peer, the concepts of a vocabulary can be distributed over a number of servers on the network with none being the authoritative master server.

Each of the above architectures bring in different pros and cons, and the final design choice will naturally depend on the needs of the implementation. The network stores may be available on the Intranet or the Internet. An intranet server (as in FIG. 7, 7-3) can store vocabularies and concepts that relate to the organization where as the internet server (as in FIG. 7, 7-4) can store vocabularies and concept can server the broad user population as a whole. The intranet and the internet implementation serve as more complete repositories for vocabularies and allow the discovery of concepts and vocabularies that are not stored locally. This kind of a mechanism can allow incremental and organic development of vocabularies, as concepts that are not found at any level can be monitored and added to suit the purposes of each level. Furthermore, as this interface can be expected to model usage patterns, there is a need for a paradigm to implement constant change. The network extensibility allows such change to be driven by actual usage. Also, it can be expected that a full store of all concepts can have large processing requirements. Thus by having the local store (as shown in FIG. 7, 7-2) as a subset, only the concepts that are used can be, kept optimizing the storage and processing requirements. For devices that have limited capabilities, the local store can be replaced by a network store altogether and accessed only through the network.

Furthermore, network server based ontology engines can offer incremental upgrades to the local vocabularies present locally through feeds or similar mechanisms. Since vocabulary selection and merging is a key activity with large consequences for the reliability and stability of the overall architecture, it is likely that such specification will need to be centrally managed. This is achieved through the centralization that a network-based server provides.

For a clearer description of the basic working of the invention, it may be desirable to describe specific embodiments for its use. In the sections below are a set of embodiments for the invention. However, it should be noted that this is neither a complete nor exhaustive list. The same invention can be embodied in a number of other fashions that are not described here without change in its essential spirit.

Semantic File System

In most file systems today, the user saves a file in a folder/directory and by giving it a filename. The folders are also typically created by the user and given a folder name. The structure of the system is such that a file exists in a folder. The folder itself may exist in a higher-level folder and so on until the root of the file system. This is organized in the form of a tree where files are leaves of the tree and folders are nodes, and each of them can have only one parent (higher level folder). For example, a file “IT Audit Report” may exist in a folder called “Audit Reports” which in turn may exist in a folder called “Audit Department” and so on. The problem with such a structure is that quite often a file may need to have two or more parent folders. Such as in the example above, the same “IT Audit Report” may also need to be in a folder called “IT Department”. The current hierarchical system makes such a classification difficult. The only way of achieving that is through the use of Short Cuts or links. This is difficult to manage. Furthermore, this system requires the user to categorize all their digital objects whether they be word processed documents, spreadsheets, pictures, mp3 files or others, on the basis of text labels structured in a tree. It is at best a reasonable solution for a few files. It does not scale.

There are major efforts underway to help alleviate this problem by bringing search technology to the desktop. Microsoft will be introducing the WinFS file system with the release of its next generation OS called Longhorn in 2006. Apple has announced a new technology called Spotlight that will be released with the Tiger version of its OS slated to be released in 2005. There are efforts underway in the Linux community to introduce such technology in projects such as Gnome storage. Apart from providing full text search capabilities, these systems can bring significant improvement in the categorization problem. These are built around concepts similar to what was introduced in the article “Semantic File Systems” by Gifford et al., Proc. Thirteenth ACM Symposium of Operating Systems Principals (Pacific Grove, Calif.) October 1991, which introduces the notion of “virtual directories” that are implemented as dynamic queries on databases of document characteristics. There has been considerable work in creating document management systems and knowledge management systems, which attempts to categorize important documents in a central location and make them available through a search interface. These are built around requirements similar to the web where the search engines create a full-text search index of the documents and append to it the ability to put metadata such as keywords. These systems have relatively successful in the organization of key documents along workflows and compliance requirements. However, they are not built to gear to the more ad hoc requirements of a file system in general. Attempts like WinFS or Spotlight are aimed at bringing these benefits to desktop users at large.

While efforts like Spotlight should improve the end-user's experience for search above what is available today, they will run into a similar set of problems that are currently faced on the web and in Information Retrieval at large. In fact in some ways, as one extends file systems like WinFS to cover entire corporate networks, the problem of search is considerably larger than the web. Google, one of the largest search engines on the web, at present indexes a few billion pages. The number of files available in an organization of a reasonable size would be in that order or larger. Furthermore, the searches in a corporate context would require far higher levels of recall and precision than anything on the web. A key requirement above and beyond full text searching in such situations is the ability to have organization-wide categorization. The ability to use ontologies like those of the Semantic Web will be an important benefit. Similarly, the adoption of such ontology based naming will be catalyzed by the user interface of this invention.

Let us consider the IT Audit report in the previous example. Let us assume that the IT Audit report is stored in the directory tree of the auditor as a pdf file as illustrated in FIG. 9. In this scenario, it is very difficult to file it in another folder based on the IT Department tree. Also, if someone other than the auditor wishes to access these files then it is difficult to find it unless they know exactly where it is. Furthermore, a typical search facility allows finding documents with extension pdf but not documents which are of the type Audit Report. With WinFS, it is possible to store the category strings as fields and grouping created dynamically. Therefore, by placing ‘IT’ in the category, this document would show up in a grouping for IT as well as ‘Audit’. However, such text based labels clearly have limitations because the concept ‘IT Department’ maybe written by different people as ‘IT’, ‘IT Department’ or others. Instead of this, if it were possible for the organization to establish an ontology like the one in FIG. 9 where there is a clearly defined type called ‘IT Audit Report’ with some basic relationships already encoded, then a document saved as a type ‘IT Audit Report’ allows a number of improvements to the current scenario. The auditor who is saving the file can specify it as an ‘IT Audit Report’ which on its own can specify to the file system significant amount of information. Thus future searches can be done for all ‘Audit Reports’ and not just .pdf. The file system knows that this file is related to the IT Department. So a search on documents related to the IT Department can bring this file. Also, searches on documents related to the Audit Department can return this document as well.

Using the user interface in this invention, it is possible to implement this in an intuitive fashion. As an example, when the user is saving the file as shown in FIG. 10, it is possible to show a dialog that allows the user to name the file as below. Such a system can be implemented in various ways including using the WinFS type system and API. Also, this may be provided as modified File Open/Save and Search functionality instead of system wide input method. However, for the purposes of this description a detailed account of the actual implementation is not given.

It is possible to have a File Save Dialog box that is generic across multiple file types.

The user enters “Audit Report” and will get a popup of candidate meanings that correspond to concepts that have the string as keywords (as described in previous sections). The user selects the appropriate choice (in this case a child concept of “Audit Report’ which is ‘IT Audit Report’ and lets the user interface to pass on the semantically marked up version of the text to the ‘Type of File’ field. The File Save Dialog application now has a clear and unambiguous definition of the type of the file. By querying the ontology, it can know further fields that may need to be entered and present a customized set of fields for the user to enter. Once the required fields are populated, the File Save Dialog can save the metadata representation of the file along with the file.

By using unambiguous machine names for concepts in the categories a number of benefits result. Each category has the same name regardless of who has input it. Thereby allowing multiple users share the same namespace for categories. The lexical ambiguity of different users using different text strings to represent the same concept is disambiguated at the user interface of the File Save Dialog. Each user can continue to use the label that they are most comfortable with without needing to change to some arbitrary firm standard. Perhaps more importantly, users in different language use the same category namespace and therefore share the same ‘folder’ on the file system. A great deal of rich semantic linkage information can be encoded in a structured fashion with few requirements posed on the user. Once a document is strong typed, many other applications can leverage it. As an example a workflow application can take the ‘IT Audit Report’ and pass it on to higher authorities for approval, etc.

Such a file system as above may be implemented on top of a file system like WinFS. Each entered machine-readable ID will serve as a metadata tag for the file that will be stored in the file system metadata database. These tags represent virtual directories and the system can show listings of files with a particular tag as it currently does with folders. Through this mechanism, a file can easily exist in multiple folders. Furthermore, as the tag is a machine-readable ID part of a vocabulary, it has a rich semantic representation that a text label cannot. The tag can have multiple parents and multiple children concepts. Thus a virtual directory can contain files not just tagged with the concept of the virtual directory but also all its children. As an example, if one opens a virtual directory tagged with the concept ‘Car’, it may contain files that have been tagged with child concepts like ‘SUV’ or ‘Station Wagon’ although none of the files were explicitly tagged with the concept ‘Car’. Furthermore, as in the example in FIG. 9, ‘IT Audit Report’ may be related to the concept ‘IT Department’ through a ‘related-to’ relationship. Thus this file may appear in a folder representation of the files corresponding to ‘IT Department’.

Essentially, the concept of a folder is a visual representation of a search query. The file system may also present a more generalized search interface to the user. Through the use of this invention, the user can specify to system the machine-readable ID corresponding to the concept that the user is searching for. This can then be matched against file on the basis of an unambiguous search. The search may return files tagged with a concept that is an exact match of the one entered by the user or one of its children. Since the narrower-concept is a transitive relation, it can also match children of children and essentially encompass all its descendants. Similarly, a parent of a parent is also a parent. So, all ancestors are also parents. In a fashion similar to current search engines, the user may input multiple concepts that can parsed together into a logical expression. Such as ‘Car’ AND ‘Japanese’ AND (NOT ‘SUV’). Furthermore, there may be a richer semantic context associated with a concept in a vocabulary than just the parent-child relationships used in the vocabulary. Knowledge representation schemes such as RDF, allow the creation of arbitrary relationships for concepts. Thus there can be any number of different relationships such as the ‘related-to’ relationship that can be used in the search criteria. In a more general case, the search may be described in a query language such as RDF query language. Also the search could be done on the basis of rules and be based on a reasoner such as one using Description Logic. The user interface of the invention can be used to specify not just concepts but also identify the relationships that user feels of relevance. In order to do so, the relationship itself can be defined as a concept within the vocabulary.

This method can work along side current text based classifications. For example, if there is no clear ontology support for the category that the user wishes to tag a file with, the method can default to a text string. In searching for documents, the machine representation of a category can be expanded to its constituent keywords to cover files that have been saved in text as opposed to ontological categories.

Existing document management systems typically try to generate metadata for documents automatically. The ability for software to adequately summarize the intent of the author is questionable. It is important to provide the author of the document the ability to easily and intuitive describe its contents as described above and use such metadata for the search process. This can be used in complement to pure text based searching as is most commonly done today. Thus the invention provides an important avenue for attacking the Information Retrieval problem that has been largely impractical till now.

P2P Semantic File Sharing

The methods described above can play an equally important role in P2P file sharing. Networks like Gnutella and others allow a completely decentralized file sharing architecture where anyone can add files to the network and any one can download it. Once a file is downloaded, it is available for other users to download allowing the network to increase the reliability and availability of the shared file. Such networks typically allow the user to search for a file based on its file name but the protocols allow for the client software to enrich the document properties through meta-data. The ability to include a shared ontology architecture and leverage a user interface such as the one described here will allow for much more accurate searches with greater precision and recall than what is available today.

As an example, an ontology for software files will allow a user to specify in the search field the concept ‘Open Source’, ‘Linux’, ‘Browser’ and the file sharing program can execute a query over all files that match this criterion even if these are not specifically in the file name. In this case, the first person adding the original file to the network will need to annotate it with meta-data in a user interface as described in the previous section. While this may be a burden for the occasional file swapper but for people who would really like to use the low cost distribution capability of P2P file sharing (like open source developers), it is a small price to pay to make their products accessible in an easy fashion.

By having unambiguous categorization in a fashion as presented above, it becomes possible to have not just a search based metaphor to the P2P network but it becomes possible to have a folder based representation as well. In fact, the differences between a local file system such as one implemented using WinFS and a P2P one like Gnutella decreases considerably, although significant differences remain in terms of availability and security.

For example, I should be able to go in to a category called ‘W3C’ and find all the papers on the field the ‘Semantic Web’. Again the components of the system that are required will be the same as the previous section and therefore is not described here. However, it is important to note that the ontology for a given P2P network may be different in significant ways from another. Each of these networks can download a version of the ontology suited for it and present it in the client software instead of a system wide service.

Smart Documents

Since the release of Office XP, Microsoft introduced a new technology called “Smart Tags”. The smart tag technology found in Office XP is an extensible API (Application Programming Interface) that enables the real-time, dynamic recognition of user input and provides a set of relevant user actions based on the text that was entered and subsequently recognized. A typical user scenario might be the following: a user is typing text into a document that contains contextual information relevant to his or her job. This content could include the names of business partners, financial information, addresses, or any relevant business data. The organization could use a smart tag to dynamically recognize a piece of data and provide relevant user actions. When the user opens the document, the relevant data appears with a small, dashed underline. The user can then place the cursor over the text to expose the smart tag actions. These actions may be any of a number of useful services such as sending email to a client, checking inventory of a product, etc.

These documents are based on tagging a piece of text in a document with XML to uniquely identify the content and context of the text that the tag encloses. The tag is defined by a unique XML namepsace and may contain properties corresponding to the context of the element being tagged. When a document is opened with a Smart tag in it, applications that can recognize the Smart Tag and associate functions that can be performed based on the content of the tag and these appear as actions on the menu that appears on the Smart Tag when the user places a cursor over it. In effect, it is an initial attempt at trying to convert a static text in a document into actionable information. Furthermore, this is not limited to Word, Excel and Front Page but also operates on Internet Explorer so that such functionality can be exploited on web pages as well.

This works by having a recognizer dll that operates in the background as a user types within the document. The recognizer uses the Smart Tag API to interact with Office application that the user is working on. If it recognizes a word or a phrase, it adds XML markup to the label (including properties if necessary) and such markup will be stored in the document stream once it is saved. This markup enables actions to be assigned to the action menu of the smart tag in document. As an example a web page that marks up the contact information of the author can be recognized by the viewer of the page and the viewer's Contacts application can present an action “Add to Contacts” for that piece of information. However, there are problems with this scheme of things. Essentially, it leaves itself open to recognizers tagging a piece of text with a semantic tag that does not fit the context of the text or does not reflect the purpose of the author. As an example, typing in “12:30 PM JST” in this document using Microsoft Word with the Financial Symbol recognizer on, tags “JST” to mean the financial ticker representing “Jinpan International Ltd.” instead of “Japanese Standard Time” as was intended by the author. This is both confusing to the reader as well as the author of the document as the system has arbitrarily assigned a meaning that was different from the one intended. Furthermore, if two recognizers recognize the same text and markup the same context in different ways, the system arbitrarily chooses one of them. As an example, if two recognizers the recognize the same smart tag (e.g. StreetNames). Let us say if A recognizes “123 Main Street” as a StreetName, while B recognizes “123 Main Street, Apt. 23”, then the system will arbitrarily choose one representation to the detriment of the other action handler.

The current invention in another embodiment can complement the functionality provided by Office Smart Tags and other similar features by allowing the user to specify in an unambiguous manner, the intended meaning. The user interface as described previously can be implemented as a system-wide input method. Thereby the semantically tagged text can be entered into an application like Microsoft Word or Excel, which can serve as the Smart Tag. The interface to the application can be much like entering text in different languages. There can be a switch to a semantic mode and using the user interface the entered text can be converted to the desired meaning through the selection of the appropriate candidate meaning shown by the input method. This would allow any document with the functionality of accepting such semantic tagging to work with this input method. Also, since the author is in control of the tagging, a number of benefits ensue. The desired meaning is marked up and not the meaning marked up by some recognizer dll in an uncontrolled fashion. Secondly, only those pieces of text that the user desires to semantically tag are tagged instead of all texts that a recognizer dll finds. Furthermore, once a semantically marked up text has been entered it is possible to add an action item that allows the user in a manner similar to filling fields in a form, to fill in property values that can be embedded with the markup. This tag can now have much richer semantic information encapsulated within it for the use of an application at the receiving end. However, this is not limited to associating an action with text.

As an example, consider the situation where a supplier would like to indicate the availability of a specific item of inventory to an online retailer with reference to FIG. 11. The retailer may provide a spreadsheet template to the supplier where they can fill in their current inventory and mail in the spreadsheet to a central system where the retailer can offer the product to its customers. In order for this to work in a seamless fashion, the supplier needs to enter the product details as per the product codes used by the retailer's application. These codes may be industry standards codes or retailer specific ones. In order to make the input process easily and error free, the retailer may include an ontology of product names and attributes that can be mounted into the ontology engine for the user interface of the supplier. The supplier can use normal natural language names for the product and have the user interface present choices of products that best match the entered string. Once the corresponding product is chosen, the user interface can semantically tag the text in the spreadsheet with the retailer's product code. Thus the spreadsheet when sent to the retailer will have a machine-readable version of the supplier's inventory that can be automatically processed by their system. In this specific example, it is interesting to note that the ontology of the products of the retailer may be very large and would not make sense to store locally. As noted earlier, the local ontology engine can serve as merely a cache and route all keyword-to-concept requests to a central engine on the network or the Internet. This allows the supplier to have access to the fully ontology only when necessary and for normal use, they can use a limited subset of the ontology that corresponds to their needs.

While all this can be implemented through the use of a custom developed system, using this method allows for a much lower cost deployment. This allows similar technology to be used for a much broader range of transaction than currently possible. This implies that even small suppliers or individuals in the above example can participate in an automated supply chain system with out large IT development costs. Furthermore, as there is a clear separation between the data and application program, the resulting system is also much easier to maintain as changes in the product ontology can be sent as version upgrades that can be downloaded and mounted on the system.

Semantic Publish and Subscribe

Publish and subscribing is a type of messaging system that relies on topic-based addressing for communication between application programs. In a publish-subscribe system, senders label each message with the name of a topic (“publish”), rather than addressing it to specific recipients. The messaging system then sends the message to all eligible systems that have asked to receive messages on that topic (“subscribe”). This form of asynchronous messaging is a far more scalable architecture than point-to-point alternatives, since message senders need only concern themselves with creating the original message, and can leave the task of servicing recipients to the messaging infrastructure. The key component of such products is the ability for any application to subscribe to messages from any other application without knowing its location or structure. These applications are ‘loosely-coupled’ and discover each other and communicate with each other over the messaging software. There are a number of variants of such software providing different messaging features but almost all of them are characterized by the concept of subject-based addressing. The actual system used for carrying and delivering the message can be in many different forms ranging from information buses, web services, SOAP, email and others. Even weblogs and RSS feeds can be considered as a form of publish and subscribe. Messaging software such as Information buses that are used in EAI or financial information systems have been around for some time. There are major products like the MQ Series or Tibco that are used to provide connectivity between systems as well as users.

The ability to use semantic web concepts in the definition of topics in such systems has many powerful advantages. This allows for the creation of ontologies that provide sophisticated namespace and subject definitions. The subscribe function may be able to match messages not just on topics but on hierarchies as well as rule based matching through the use of a general purpose reasoner. This can open up significant new ways to interact with information that is event-based like news stories, etc.

The present invention in another embodiment may serve as a basic user interface for users to leverage functionality in a semantic publish and subscribe. As an example, a trader in an investment bank would like to subscribe to all information within his/her firm regarding a type of instrument that he/she trades in. This information may come from different branches in different physical locations or even in different countries. Information may come from different departments like research or sales. There may be different types of information like the release of a research report, change in regulation, a customer conversation, market activity, another traders analysis, etc. Currently, the trader would need to have a custom-built system that covered each such requirement. However, the common denominator for all these types of uses is that the information may be communicated in digital form as a message. It is possible using Semantic Web technologies like RDF to give a rich semantic description of this digital object and pump such a description as meta data with the original message down a messaging bus. It is possible for a generic event viewer on the trader's desktop to subscribe to events based on a semantic description. As in the diagram given in FIG. 12, the user can indicate an interest in ‘JGB’, which are Japanese Government Bonds.

By subscribing to this topic, the system has a machine-readable name to match against events. Since this encoded as a machine-readable id, all systems can share a common definition of this meaning. By subscribing to ‘JGB’, the user also subscribes to all other kinds of instruments that are JGBs including 10 year, 20 year and other bonds. Since any digital item such as a news story, research report, trader analysis, regulatory changes, etc. that can be classified as anything within this hierarchy can have a corresponding URI tag, it can be matched to this subscription. A major difference between current EAI buses and such an approach is that having an open and standard definition of the namespace within a messaging bus, truly serendipitous subscriptions can take place. By leveraging ontologies such as those found in the user interface of this invention, messages can be tagged with meta data corresponding to concepts that are most commonly used by a subscriber. Furthermore, it is possible to have more sophisticated matching criteria apart from topic subscription. Any subscription can be looked upon as a persistent query and can be represented in a more general purpose query language such as an RDF Query Language. This may include multiple concepts, logical expressions as well as matching based on property values (relationships). Also, matching itself can be done through reasoners than can leverage rules, Description Logic and other methods that allow for inferencing in the match process. The user interface of this invention allows an average end user to take advantage of such functionality.

Semantic Weblogs

Today's web is primarily a read-only web. Web sites are created by a few high profile publishers. The average user is reduced to the role of a silent consumer of these pages.

Blogging or weblogs are an attempt to make this communication two-way. Blogging is a lightweight web publishing paradigm which provides a very low barrier to entry, useful syndication and aggregation behavior. With blogging tools, even an average user is able to achieve a simple “Push-button Publishing” of content.

Much of the power of blogging comes from its ability to syndicate and share information using XML metadata. One format for such metadata is the RSS (RDF Site Summary) 1.0 standard which is based on RDF, the language of the semantic web. Essentially, the updates in a weblog can be marked up in RDF in a rss summary file and put in a file on the web server. The end-user can use an RSS News Aggregator to read these summary files on a regular basis and present the “news” to the user as it occurs. This allows for a truly powerful paradigm where an average user can keep tabs of changes in information at sites that he is interested in without having to continuously visit it.

Blogging is currently moving into mainstream with a growing number of content providers like Yahoo! News as well as Amazon providing RSS Feeds to their content. However, it is hoped that the true potential of weblogs will be realized through a content syndication mechanism that is truly democratic. This implies that one does not have to be a reporter in a well-established media company to have their voice heard. Through weblogs, any one can publish on the web and have reasonable chance to being heard. Hopefully, it will be the content of the post and not just the brand name of the source that will allow it to be read. Such an editor-free environment where anyone can participate is truly revolutionary and leverages the network nature of the web.

One of the problems with weblogs (even today) is the sheer volume of information. Although blogging is still fairly limited on the web, there is a deluge of content that is being created every second. Even registering a relatively small number of feeds can flood the RSS News Aggregator with many hundreds of stories per day. It is important to segment the blogs into categories such that users can express interest in the categories that they are interested in and bring down the number of irrelevant posts that they are subscribed to. In his paper “Semantic Blogging: Spreading the Semantic Web Meme”, Steve Cayzer presents the idea of using Semantic Web technologies in order to categorize feeds and posts. He presents the idea of defining a category ontology based in URIs so that any blog written by any blogging software will be able to share the same category space. Each entry has a rss file tagged with category URI in RDF. Blog entries can be pulled together in central server and be categorized in an unambiguous manner. The present invention in another embodiment can perform a significant role in this use.

It is likely that the requirements of a category ontology will be relatively small in terms of the number of semantic relations (mostly it should resemble a tree-like structure). However, it is likely that the number of categories will need to be large enough to implement a sufficiently fine-grained categorization to meet the actually interest of the users. As an example, the category ‘Politics’ can have a sub-category ‘Elections’ which has a sub-category ‘US Elections 2004’ which has a sub-category ‘Democratic Nomination’. The user should be able to select the appropriate level of detail and subscribe to all posts on that and its sub-categories. Furthermore, the user should be able to select the intersection of categories like ‘Operating System’ and ‘Security’.

Unlike traditional news organizations, a normal blogger does not know structured publishing paradigms and is not specialized on specific topics. So the typical blogger will post on a wide range of topics that changes as per their interest at the time. The only way to implement categorization is to mark each post with the relevant categories and accumulate such posts at a central server for categorization and presentation to news aggregators. This can be done by marking up the RSS entry with semantic categories and having the central server sort all these entries on that basis. Furthermore, news readers should be able to subscribe to a set of categories at the central server and have a customized rss file created for them matching their subscriptions. For each of these two stages, it is necessary to have a user interface that allows the blogger or the news reader to specify the relevant semantic categories. The user interface of the current invention can play a key role in making such technology possible. Not only can such an interface be an application resident on the person's local device, it can also be delivered in the form of a web page. The functionality of being able to enter text, have choices for meanings presented and the ability to view and select sub-categories can be implemented with HTML and scripting technologies like JavaScript that can work on a normal web browser.

It is important to note that such a design is not limited to blogging and can be implemented by a web site where a user may be interested in updates. As an example, the Patent Office website that allows user to search for patents that correspond to certain classification or other criteria may be able to present a service where clients can register subscriptions and any new patents or other events that match the criteria of the subscription is encoded into an rss file that a news reader on the client side can read. This allows the end-user to get streaming updates of events relevant to them in a timely fashion. This also true of online retailers who wish to announce new product updates to users that the users have subscribed an interest (or the retailer thinks they may be interested in) and many other fields.

It is likely that both the user interface and some generic ontologies that are broadly used will be implemented as a generic solution so that each individual service provider will be able to utilize generic and tested components instead of having to make their own. It is also likely that over time, this form of the user interface will inter-operate with the other forms described in previous sections. It is also important to note that the above embodiments are a specific subset of the broader theme of semantic publish and subscribe where the actual events being subscribed to are those of changes in a web site.

### OTHER EMBODIMENTS

There can be a number of embodiments that are uniquely empowered though the use of such a user interface. The embodiments above have focused on primarily two kinds of applications. One where a digital asset is marked up with metadata through the use of the user interface (such as the semantic file system and semantic pub/sub). The other where the user interface is used to embed metadata into the digital asset itself such as smart tags. A further example of the former is semantic enabled searching. Document searching or Internet searches can be enriched with manual annotation that allows the document creator to highlight concepts within a document so as to allow search engines to find it better. Much of Information retrieval has focused on mechanisms that deal with raw text in a document as it was not considered practical to have users enter metadata. It is widely recognized that while such indexing based on text is useful, there exists a distinct requirement for a human mediated tagging of the contents of a digital article. Therefore, a search architecture empowered in such a fashion where both the creator of the digital asset and requester can use such an interface, will yield in significant improvement in both recall and precision. Tagging of digital media such as music, pictures, movies can all benefit from such an architecture. Furthermore, as noted earlier in the section on Semantic File Systems, the tags themselves can be a part of a rich semantic ontology. Therefore, the user interface for searching can be augmented to provide a broader query language based search semantics as well as a rule based search that is augmented with a general purpose reasoners.

A further example of the second kind of application is machine translation. Similar to the smart tag embodiment, a machine translation software can use this interface to disambiguate meaning and embed this meaning along with the text. This can be done with an NLP software that scans the input of user to detect semantic or lexical ambiguities and prompts the user to resolve them through the user interface. Once all such ambiguities have been resolved, it may be possible to generate a much better machine translation of documents to any language. Such a translation software can also go through a pre-existing natural language document and finds places where there is lexical ambiguity of meaning. It can highlight these and the user can double-click them to open the user interface that allows them to disambiguate the meaning of the word.

In general, the purpose of embedding a tag in a document could be manifold. Such tags could represent directives that an application parsing the document can act on. A simplified example of this is HTML where the tags serve as directives that allow a browser to render the text in a document. However, such directives could be anything through the use of a generalized markup scheme such as XML or RDF. As an example, a document may contain the directive ‘Backup’ that could be parsed by an automated backup software and makes sure that the document is backed up in a regular basis. In this more general case, the user interface of this invention allows the user to intuitively specify the directives in a fashion that allows serendipitous interaction between applications.

As has already been noted in the Smart Documents section, embedded tags can serve the function of having actions allocated to a text string. The more generalized version of this is to associate a text string with a machine-readable ID that corresponds to a concept, and matching this ID to a function or a service that accepts this as an argument in its function signature. The most basic example of this, as noted previously, is an application that takes the ID, refers to the ontology of the concept of the ID, and generates GUI Dialogs that allow the user to specify different property values for this concept. However, there can be an arbitrarily large number of applications that qualify. Such applications may resident locally in the machine of the document or over the network in the form of web services or RPC. Thus, the use of machine-readable IDs from vocabularies that are open world in nature allow a structured and generic method to implementing Smart Tags.

The user interface of this invention can be advantageously used in commands as well.

Unlike most of the uses highlighted previously where the metadata tags produced by the invention were primarily in the form of categories (and hence, ‘nouns’), the same might be used for system ‘verbs’ as well. In general, commands or functions within computers are implemented in the form of CommandName and a set of arguments. In the case of the Command Prompt in Windows, the command is in the form of a file and may be executed by entering its full file path and name. The command takes optional arguments. In a semantically enhanced version of such a shell, the command may be input through the user interface which allows the user to put in the form of the command most familiar to him and have the interface translate it into a machine ID (in this case the full path of the command file. In a more generalized version of this, a number of common actions traditionally done using GUI metaphors like icons and the Start menu, may be complemented by a simple search screen that allows the user find the functionality they are looking for. For example, in order to do change the network settings, the user may simply type ‘Network Settings’ and disambiguate it to the correct meaning in the context of a system vocabulary. This can be reliably matched to a Control Panel program to alter the settings.

The user interface may be implemented in the form of a voice dialog where voice recognition replaced keyboard input of text by the user and a text-to-speech synthesis engine may serve the purpose of offering candidates for the user to select. Or this could be used in combination with the traditional input devices such as a keyboard and a mouse. However, the above mentioned example of using the user interface in this invention to issue commands can be advantageously implemented in a voice enabled manner. The operation will be similar to the one described above.

The same approach could be taken to another level of granularity, where functions within a program can be marked up with metadata using machine-readable IDs from a vocabulary and can be reliably matched to those entered by a user. Currently, systems such as .Net and CLR already implement a language and run time that supports metadata tagging in programs. These tags are used to implement automated ways of generating web services from a source code file. However, interaction at this level with a user (through the user interface of this invention) could possibly have some unique uses. Such interaction may need to be moderated through GUI Dialogs, etc., but the ability to have user interaction at the function level rather than at command level may be interesting. As an example, instead of ‘Network Settings’ in the above example, if the user had typed ‘DNS Settings’, which may be a part of the Network Settings applications, then the corresponding DNS Setting screen can be delivered.

Essentially, any application program that can benefit from a user disambiguating semantic meaning may benefit from the user interface in this invention. This invention can be present in an embodiment that serves such a function in all these cases.

### BRIEF SUMMARY OF THE INVENTION

According to a broad definition of the present invention, an ontology engine is provided, comprising: a storage holding a vocabulary, the vocabulary including a plurality of machine-readable IDs each corresponding to a concept and at least one keyword corresponding to each machine-readable ID; an input interface unit that accepts text information, selects those machine-readable IDs whose keywords match up with the text information, and returns a list of candidates each corresponding to one of the selected machine-readable IDs and including a corresponding description; a human interface unit that allows a user to select one of the candidates; and an output interface unit that returns one of the machine-readable IDs corresponding to the candidate selected at the human interface.

According to another aspect of the present invention, the ontology engine, comprises a storage holding a vocabulary, the vocabulary including a plurality of machine-readable IDs each corresponding to a concept and at least one keyword corresponding to each machine-readable ID; an input interface unit that accepts a machine-readable ID; and an output interface unit that returns at least one of the keywords corresponding to each accepted machine-readable ID.

### BRIEF DESCRIPTION OF THE DRAWINGS

Now the present invention is described in the following with reference to the appended drawings, in which:

FIG. 1 is a diagram illustrating the semantic web stack;

FIG. 2 is a diagram illustrating the basic graph in RDF;

FIG. 3 shows a basic user rendering of the RDF graph;

FIG. 4 is a diagram illustrating a small portion of the Amazon.com (trademark) book taxonomy;

FIG. 5 is a screen image of a user interface of search software embodying the present invention;

FIG. 6 is a screen image of a sample form that is filled by using the user interface according to the present invention;

FIG. 7 is a diagram illustrating a possible layout of the ontology engine according to the present invention;

FIG. 8 is a logical graph representation of vocabularies stored in the ontology engine;

FIG. 9 is a diagram comparing the conventional hierarchical file system with the file system based on the semantic ontology;

FIG. 10 is a screen image of a file save dialog based on the semantic input system according to the present invention;

FIG. 11 is a screen image of cells of a spreadsheet software based on the semantic input system according to the present invention;

FIG. 12 is a screen image of a subscription topic input page in a semantic publish and subscribe system according to the present invention;

FIG. 13 is a block diagram of a computing environment suitable for implementing the present invention;

FIG. 14 is a flowchart of a human interface for a semantic input system according to the present invention;

FIG. 15 is a flowchart of a query process in an ontology engine according to the present invention;

FIG. 16 is a flowchart of a process of mounting a new vocabulary in an ontology engine according to the present invention; and

FIG. 17 is a flow chart of a process of unmounting a new vocabulary in an ontology engine according to the present invention.

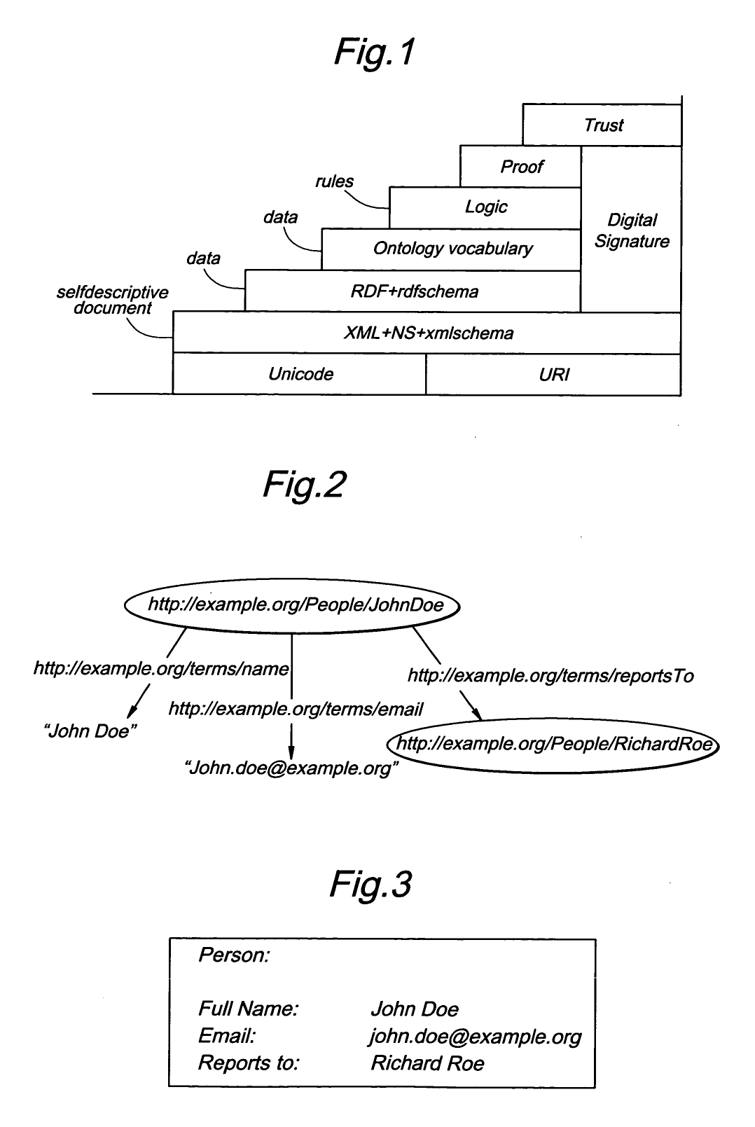

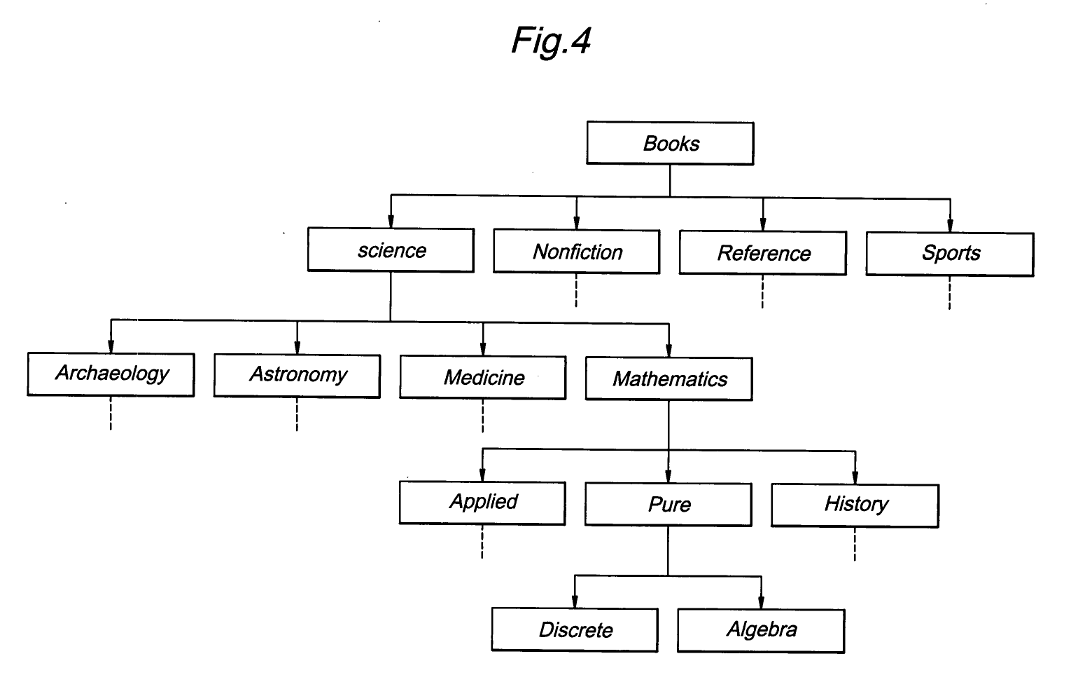

### DETAILED DESCRIPTION OF THE PREFERRED EMBODIMENTS

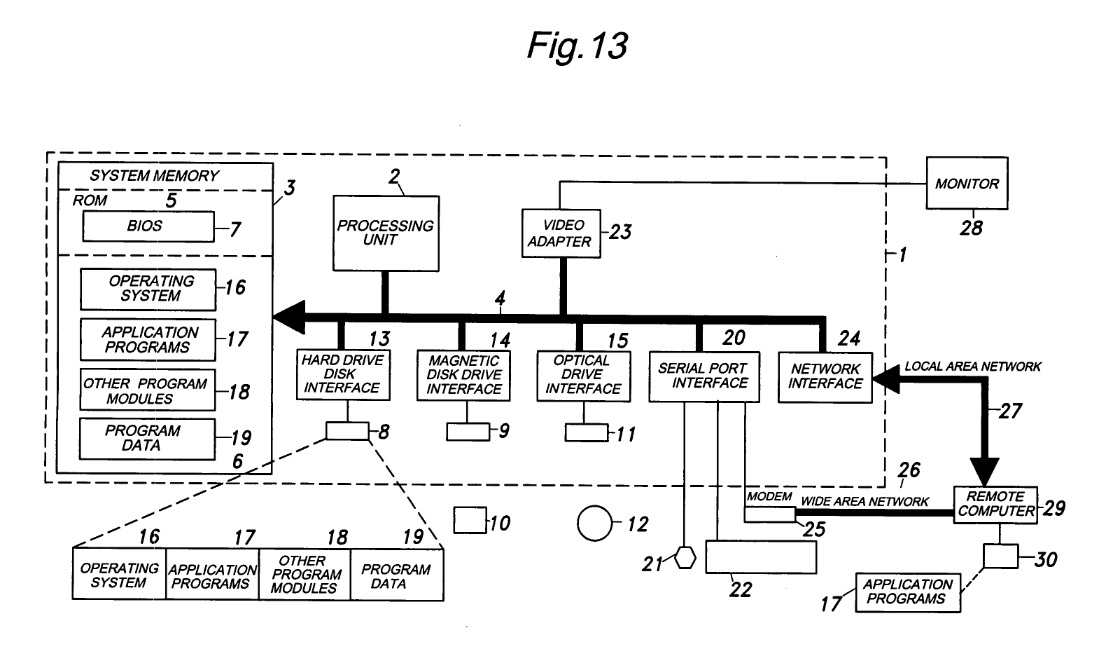

FIG. 13 provides a brief, general description of a suitable computing environment in which the invention may be implemented. The invention will hereinafter be described in the general context of computer-executable program modules containing instructions executed by a personal computer (PC): Program modules include routines, programs, objects, components, data structures, libraries, etc. that perform particular tasks or implement particular abstract data types. Those skilled in the art will appreciate that the invention may be practiced with other computer-system configurations, including hand-held devices, multiprocessor systems, microprocessor-based programmable consumer electronics, network PCs, minicomputers, desktop computers, engineering workstations, mainframe computers, and the like. The invention may also be practiced in distributed computing environments where tasks are performed by remote processing devices linked through a communications network. In a distributed computing environment, program modules may be located in both local and remote memory storage devices, and some functions may be provided by multiple systems working together.

FIG. 13 employs a general-purpose computing device in the form of a conventional personal computer 13-1, which includes processing unit 13-2, system memory 13-3, and system bus 13-4 that couples the system memory and other system components to processing unit 21. System bus 13-4 may be any of several types, including a memory bus or memory controller, a peripheral bus, and a local bus, and may use any of a variety of bus structures. System memory 13-3 includes read-only memory (ROM) 13-5 and random-access memory (RAM) 13-6. A basic input/output system (BIOS) 13-7, stored in ROM 13-5, contains the basic routines that transfer information between components of personal computer 20. BIOS 13-5 also contains start-up routines for the system. Personal computer 20 further includes hard disk drive 13-8 for reading from and writing to a hard disk (not shown), magnetic disk drive 13-9 for reading from and writing to a removable magnetic disk 13-10, and optical disk drive 13-11 for reading from and writing to a removable optical disk 13-12 such as a CD-ROM or other optical medium. Hard disk drive 13-8, magnetic disk drive 13-9, and optical disk drive 13-11 are connected to system bus 13-4 by a hard-disk drive interface 13-13, a magnetic-disk drive interface 13-14, and an optical-drive interface 13-15, respectively. The drives and their associated computer-readable media provide nonvolatile storage of computer-readable instructions, data structures, program modules and other data for personal computer 13-1. Although the exemplary environment described herein employs a hard disk, a removable magnetic disk 13-10 and a removable optical disk 13-12, those skilled in the art will appreciate that other types of computer-readable media which can store data accessible by a computer may also be used in the exemplary operating environment. Such media may include magnetic cassettes, flash-memory cards, digital versatile disks, Bernoulli cartridges, RAMs, ROMs, tape archive systems, RAID disk arrays, network-based stores and the like.

Program modules may be stored on the hard disk, magnetic disk 13-10, optical disk 13-12, ROM 13-5 and RAM 13-6. Program modules may include operating system 13-16, one or more application programs 13-17, other program modules 13-18, and program data 13-19. A user may enter commands and information into personal computer 13-1 through input devices such as a keyboard 13-22 and a pointing device 13-21. Other input devices (not shown) may include a microphone, joystick, game pad, satellite dish, scanner, or the like. These and other input devices are often connected to the processing unit 13-2 through a serial-port interface 13-20 coupled to system bus 13-4; but they may be connected through other interfaces not shown in FIG. 13, such as a parallel port, a game port, or a universal serial bus (USB). A monitor 13-28 or other display device also connects to system bus 13-4 via an interface such as a video adapter 13-23. A video camera or other video source can be coupled to video adapter 13-23 for providing video images for video conferencing and other applications, which my be processed and further transmitted by personal computer 13-1. In further embodiments, a separate video card may be provided for accepting signals from multiple devices, including satellite broadcast encoded images. In addition to the monitor, personal computers typically include other peripheral output devices (not shown) such as speakers and printers.

Personal computer 13-1 may operate in a networked environment using logical connections to one or more remote computers such as remote computer 13-29. Remote computer 13-29 may be another personal computer, a server, a router, a network PC, a peer device, or other common network node. It typically includes many or all of the components described above in connection with personal computer 13-1; however, only a storage device 31-30 is illustrated in FIG. 13. The logical connections depicted in FIG. 13 include local area network (LAN) 13-27 and a wide-area network (WAN) 13-26. Such networking environments are commonplace in offices, enterprise-wide computer networks, intranets and the Internet.

When placed in a LAN networking environment, PC 13-1 connects to local network 13-27 through a network interface or adapter 13-24. When used in a WAN networking environment such as the Internet, PC 13-1 typically includes modem 13-25 or other means for establishing communications over network 13-26. Modem 13-25 may be internal or external to PC 13-1, and connects to system bus 13-4 via serial-port interface 13-20. In a networked environment, program modules, such as those comprising Microsoft Word which are depicted as residing within 13-1 or portions thereof may be stored in remote storage device 13-30. Of course, the network connections shown are illustrative, and other means of establishing a communications link between the computers may be substituted.

Software may be designed using many different methods, including C, assembler, VisualBasic, scripting languages such as PERL or TCL, and object oriented programming methods. C++ and Java are two examples of common object oriented computer programming languages that provide functionality associated with object oriented programming. The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Any of the foregoing may be supplemented by, or incorporated in, specially-designed ASICs (application-specific integrated circuits).

The basic function of this invention is to serve as a user interface between man and machine that operates at a semantic level. It focuses on providing the ability for a person to communicate to an application their desired meaning. This invention recognizes that in order for efficient communication to take place there must exist a matching between the words that a person uses to describe a concept and the machine representation of that concept. In order to achieve this, the invention relies on technologies like ontologies that the machine uses to represent knowledge of such concepts. Such concepts and ontologies can be represented by technologies like RDF and the Semantic Web. A concept within an ontology in RDF is stored is referred to by its URI, which serves as a unique ID for it in the ontology. By referencing the resource description referred to by the URI, it is possible to acquire knowledge about it stored in the ontology. In effect, it serves as the machine's name or ‘word’ for that concept. The primary purpose of this invention is to establish a mapping between the user's ‘word’ and the machine's ‘word’. The invention leverages ideas from lexical dictionaries and thesaurus mapping, to do this. At its most basic level, it uses methods similar to looking up a dictionary to find a concept but extends this by adding the ability of pointing to an entry and saying “This is what I mean”. In order to implement such an interface in real world applications, a number of requirements like the ones mentioned below may need to be satisfied.

The dictionary or the ontology needs to be application-driven, essentially embodying the concepts and knowledge that the application needs in order to function. (Thus the application needs to have control over what concepts it presents to the user). All applications must present a common user interface, otherwise it is not practical for the end-user to remember what each concept means. (Therefore, the user interface needs to implement an ontology engine that is open-world, which means that it can mount/unmount ontologies as per the application requirements).

Each application can have varying knowledge requirements for each concept, therefore the ontology engine needs to present minimal constraints on application ontologies apart from what is minimum required to implement the interface. At the same time, it needs to be able allow the application to further define the concept to an arbitrary level of complexity without placing any constraints on it. (Therefore, the definition of a vocabulary in this invention has been limited to the minimum required to serve as an index to a much richer ontological description used by the application).

Unlike an ordinary dictionary, the concepts used in the interface will correspond to normal usage of an end-user and not standardized terms like those in a language. Therefore, there is a need for constant change for such concepts. Vocabularies need to be upgraded and possibly downgraded over time. No single ontology engine is likely to be able to encompass all terms for everybody, therefore there needs to be a mechanism to discover concepts by querying over a network.

It is preferable to have a single user interface attach to multiple applications for a number of reasons, not the least of which is to free up an application developer from having to manage semantic disambiguation of input on their own. Therefore, there is a need for such a user interface to be implemented as system-wide service.

Such an interface, needs to embed itself recursively in broader interface metaphors like dialog windows such that a rich communication medium is presented to the user. Also, in order for multiple applications being used by the same user to work cooperatively, the ontology engine needs to perform the tasking of mapping between their concepts and serve as the central index for looking up concepts between them.

The user interface of this invention consists of the following components
An input/output interface with an application
An ontology engine for storing vocabularies
A human interface for interacting with the user

The input/output interface with an application performs two basic functions. It allows the application to have the user interface to convert an input text to a machine-readable ID that corresponds to the meaning intended by the user. It also allows an application to perform concept-to-keyword, concept-to-description and concept-to-concept mapping. The ontology engine serves as a store for vocabularies of concepts and the ability to match keywords and concepts as well as concepts and concepts. The human interface provides the ability to present to the user, candidates that match a given input text and allow the user to select the concept corresponding to the intended meaning.

All three components of the user interface may be implemented completely within a single application. Or they may be implemented independently depending on the usage requirements. The input/output interface could be implemented as a local function call in the case the user interface is completely built within a single application. It could also be implemented as a call to shared library, dll, components if the user interface is implemented within the same computer but as a system level service form multiple applications. It could take the form activating an input method if the user interface is implemented as a system-wide input method for text. It could take the form of an RPC call like CORBA, RMI, DCOM, .Net remoting, web services, HTTP, stored procedures, etc. if the user interface is implemented over a network. The ontology engine may be implemented completely within the application or implemented separately from the application. The ontology engine could be implemented as a daemon, system service, web service, etc. depending on the needs of the usage. The store for the ontology engine may be based a file-based storage, DB based storage or based on a modem file system such as WinFS that is scheduled to be released in a future version of Microsoft Windows. The human interface component may be implemented through a Graphical User Interface, Voice Dialog, etc. The overall user interface may be present in system components such a file system viewer like Windows Explorer or Apple Mac Finder. It could be embedded in components like File-Open or File-Save. It may be implemented completely within a single application as windows or as a GUI component such as a text component or text box component. It may be implemented as dialogs within a system-wide input method. It may also be implemented over the web through web pages using HTML and a scripting language like JavaScript. A person familiar with this domain will note that all of these implementations do not diverge from the basic idea of this invention.

In its most basic form, the present invention allows an end user to convert an entered text to a semantically unambiguous machine representation of meaning as given by a machine-readable ID. This ID may be globally unique such as a URI. Or it may be unique within the vocabularies present in the ontology engine. Or it may only be unique within the vocabulary that it is housed in. The knowledge representation around this ID may be achieved in a number of different formats including the use of Semantic Web technologies such as RDF and OWL.

The rest of this description will be given assuming that the user interface is implemented as a system wide such as an input method, and leveraging Semantic Web Technologies. However, this is merely to describe the system in an implementation that is open and multi-purpose. The same can be applied in an alternate or more restricted fashion without departing from the basic inventive concept or its core utility.

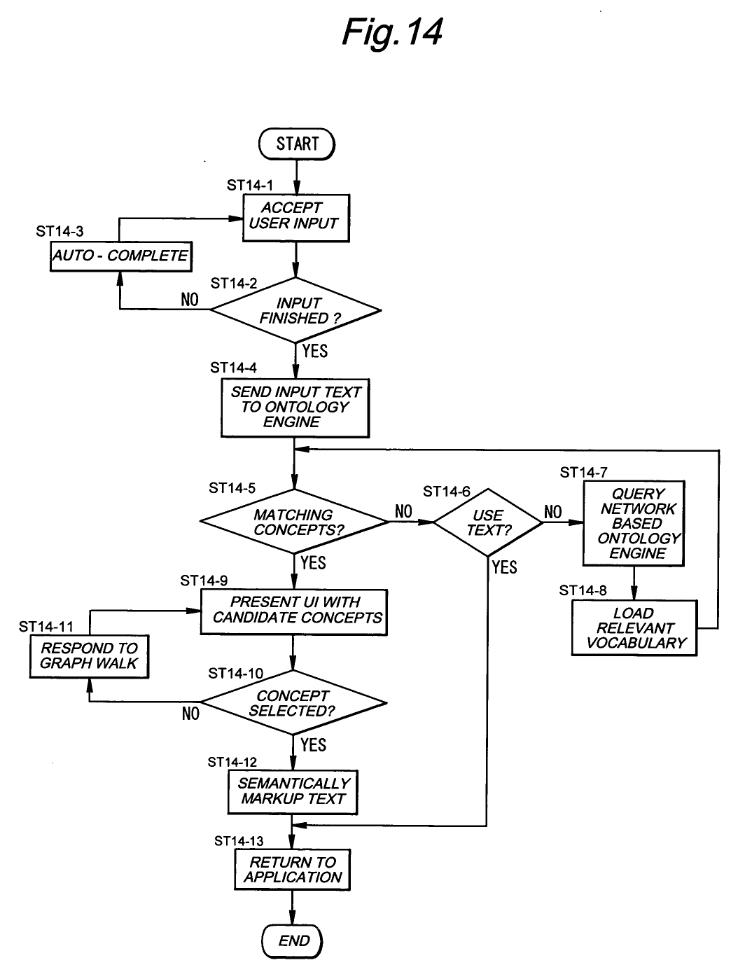

The basic flow chart for the processing of the human interface component is shown in FIG. 14. The application can communicate with the user interface through the input/output mechanism. In the case of an input method style implementation, the user can toggle to it with a reserved keyboard sequence in a manner similar to an East Asian Language input method. Similarly, the interface may offer multiple editing formats that allow the user to enter in text. These may include editing styles like on-the-spot, over-the-spot, off-the-spot and root window. This can work in conjunction with existing input methods or it may operate on its own. During the initial handshake, the application may negotiate with the user interface its preferred locale or language setting as well as describe the vocabularies that it wants to restrict the candidates to. An application that does not support semantic input can indicate it so that the user interface is not used. Once in the semantic input mode as shown in 14-1, the text that the user enters can be compared against the index of keywords stored in the ontology engine. Inline auto-completion as shown in 14-3, can take the sub-string entered and match it against existing keywords a list of matching keywords may be shown in a drop down menu and the text may be auto-completed inline with the smallest matching keyword. The keywords and description entries may be categorized by their locale and presented to the user as per the user's locale preference. By having the keywords and description in the ontology engine in multiple locales (as described in the Basic Description section), the user interface can be extended to support multiple languages.

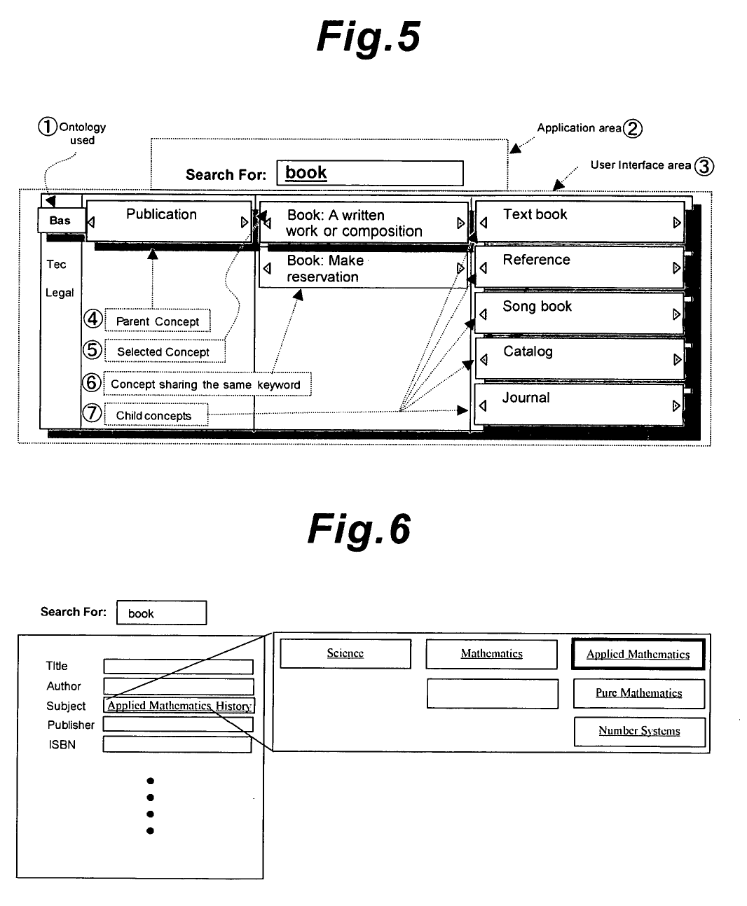

Once the user has finished the input as in 14-2, they can indicate it to the system with an action like a pre-determined key sequence. At this time, the human interface can take the input text and query the ontology engine for matching concepts as shown in 14-4. The ontology engine may be in the same application as the human interface or in a separate process or a separate machine. Depending on the implementation. This query can be made as a local function call or an RPC of some type. In 14-5, the ontology engine searches an index of keywords to match against the text. If the search of the index returns no matching concept, the user may be presented with a choice of leaving it as a text string (14-6) or to search a network-based ontology engine for a vocabulary that contains keywords that match the input text (14-7). If such a vocabulary is found, then the user has a choice of getting and adding the vocabulary to the ontology engine. If there is at least one matching concept, the set of matching concepts are given as candidates (14-9). This may be done through a GUI panel as described in the Basic Description in FIG. 5. The candidates may be labeled with the keywords and/or the description in the relevant locale of the user. They may be ordered in decreasing order of frequency of use of the keyword with the concept to allow the user to quickly specify commonly used concepts. In order for the user to understand the context of the candidate better, the user may also be shown which vocabulary the candidate comes from as well as its parents and children. Each concept belongs to a vocabulary and the corresponding vocabulary may be shown in the extreme left side of the interface window as shown in FIG. 5. Also, the user may choose to restrict the candidates to those from a particular vocabulary or set of vocabularies and can do so by selecting the relevant vocabularies in this panel. A cursor is positioned at the top concept (the most frequently used concept) and the user can scroll the cursor up or down across the candidate concepts. In many situations, showing its parent and child concepts can further disambiguate a concept. This is done through optionally implementing a left panel showing the parents of the selected concept in the central panel and the children concepts in a right panel. The concept graphs are based on the relationship narrower-Concept with concepts as vertices and the relationship as edges. The relationship defines that if Concept B is a narrower-Concept of Concept A, then it is a child of Concept A. The ontology engine requires that such a graph is a DAG. Therefore, any given concept can have multiple parent and child concepts linked to it as long as there are no loops in the graph. In order to walk the graph (14-11) from the selected concept in the central panel, the left or right key can be used to indicate moving up or down the graph. This walking may be presented to the user in a separate window or done in the existing set of panels with each set of panels changing to accommodate the new view of the graph. The up and down keys can also be implemented by using a mouse to select the corresponding concept. The left and right keys can be substituted in a similar fashion by clicking the desired concept with a mouse.

Once the concept corresponding to the user intended meaning has been determined, the user can select the concept with a pre-determined key sequence or by clicking it with a mouse. This concept may be one of the candidates of the originally entered text, or it may be a concept on the graph of on of these candidates. If it is not one of the original candidates, then the entered text is changed to a corresponding keyword of the selected concept. This may be selected either on the basis of frequency of use or by any other criteria. As in 14-12, this causes the user interface to markup up the entered text with semantic tags (RDF) that make it correspond to the selected concept. This object is passed to the application for further processing. It is anticipated that the application will use some visual metaphor to indicate that the displayed text is actually a semantic concept. This can include a different font or font style as well as an underline. Furthermore, the application may allow for a ‘tool-tip’ (or a transient window attached to the cursor) if the cursor is placed above the text that gives a meaning defined by the keywords and description. Furthermore, the application may present a context menu on a right-click that list the set of services, operations, actions, etc. that can be associated with this information object. As will be described in more detail in this section, the basic object model required of a vocabulary by this invention is just attributes like keywords (and their usage frequency), a description, etc. However, a given concept can have a much richer ontology with many more attributes and relations. Depending on the requirements of the properties described in these ontologies, the application can offer further entry screens for these attributes. Attaching a context menu to the semantic-tagged text can be one way to do this. In such forms, the user inputs into the fields using normal input for scalar values and semantic input for fields that require semantic values. This may be compared to the conversation metaphor described earlier where the speaker and listener both have some common understanding of a meaning given by a word. The speaker may have greater knowledge of the word and may have to describe the aspects of the concept that the listener does not understand if the contents of the conversation require it. Similarly, it is quite likely that each concept identified by the user interface of this invention can require considerable amounts of the knowledge and data to be specified. However, each use will require a different amount of this. Thus, each application may require a different set of property values that a user needs to fill in terms of the concept entered by the user to the application through the user interface. Therefore, it may not be desirable to include such dialogs in a general user interface but may be useful in an embodiment that is specific to an application. It is also likely that the application that uses the ontology will offer dialog windows that allow the user to populate such property values in forms.

In the filling of such forms, it must be noted that certain properties can require classes or individuals that can be entered through a recursive use of the user interface. Furthermore, it may also be desirable to allow the user to specify new properties and fill them. This can be done through the use of the user interface as well. Once all the required fields have been filled, the form can be closed and the entered values can be included in the mark up for the semantic tagged text. This editing function may also serve as the minimum list for such a context menu. This dialog may also allow the user to specify user-defined keywords or aliases to a concept as well that can be used to update the ontology engine with a user-defined vocabulary.

In the case that a phrase or a sentence has been entered (as may be the case in a semantic document application such as machine translation), this invention may be used along side a NLP parser to identify concepts of semantic ambiguity and have the user disambiguate them. If there are multiple such words or phrases in the entered text, then each can be underlined and the user can toggle between them using the tab key and performing disambiguation one concept at a time. As skilled practitioners in this field will note, the method of disambiguation described in this invention may also be implemented in a number of other user interfaces apart from a graphical user interface such as a voice input, sign language, etc. without departing from the spirit of the invention.

The ontology engine houses the stored vocabularies of the user interface. The requirement placed on vocabularies is quite basic. Each concept needs to be given a unique ID within a vocabulary that serves as the machine ‘name’ for that concept. This may be done using URIs as is the case in RDF. Each semantic meaning can occur in a number of different vocabularies. These meanings may be mapped with the Exact-match relation to indicate they are the same or they may not be mapped. If they are mapped to be the same, only one concept appears in the user interface. If they are not mapped, then all such concepts appear in the user interface but with a clear indication of which vocabulary the corresponding concept is from. For each concept, the vocabulary stores at least one and most likely multiple keyword attributes, each of which is a text string of a word-form or phrase that represents the concept that is represented by the concept. Such keywords can be internationalized using locale properties such that keywords in each natural language may be stored corresponding to the concept.

The ontology engine keeps track of the frequency of use of keywords with concepts. The concept most often used with a particular keyword as well as the keyword most often used with a particular concept is monitored. This allows the ontology engine to present candidates sorted by usage against a keyword. As will be described later in this section, there is also a requirement to find most commonly used keyword against a particular concept. Also, the ontology engine allows the user to specify and store zero or more ‘keyword’ attributes associated with each concept that are like the other ‘keyword’ attributes but are entered by the user and stored in a vocabulary specific to the user. These user entered ‘keyword’ attributes can be held locally in a user-specific ontology and serves the function of aliases. Furthermore, a text string called description may describe each concept. The description can consists of words, phrases, sentences, etc. such that it provides a definition of the concept. This description may optionally be used as a keyword as well but it is likely to be kept separate from the index and stored as a property for the concept. Each concept is linked to at zero or more concepts through a directed relationship called ‘narrower-Concept’. The only exception to this case may be the ‘root’ concept of a graph, which has no concept higher than it. This defines a parent-child relationship between concepts. As an example, ‘apple’ is a ‘narrower-Concept’ of ‘fruit’ links the ‘apple’ concept to the ‘fruit’ concept in a way where the meaning embodied is that ‘apple’ is a child concept to ‘fruit’. A concept may have multiple parents and have multiple child concepts connected through this relationship. The only requirement is that the resulting graph of concepts (nodes) and the ‘narrower-Concept’ relationship (edges) is a directed acyclic graph.

This ontology may be represented in a number of different ways but the preferred embodiment would be in RDF, which is the standard language of the semantic web. In an RDF representation there are number of design choices for its implementation that need to be considered on the basis of the requirements for the use of the application. Essentially, it boils down to the fact that a significant amount of activity for this user interface will be in describing categories that implies property values that are in the form of classes. While this does not represent an issue if the application requirements do not need Description Logic based reasoning or computational guarantees, in other cases such an approach may not be acceptable. For a detailed review of such choices, please refer to Representing Classes As Property Values on the Semantic WebW3C Working Draft 21 Jul. 2004, http://www.w3.org/TR/2004/WD-swbp-classes-as-values-20040721.

In this description, the invention is described as an index of concept Individuals that refer back to their representative classes through an annotation property thereby allowing conformance with OWL-DL requirements. This allows the vocabularies to be compatible with reasoning systems and gives computational guarantees, but an implementation that does not require this capability can relax this constraint without substantially losing the spirit of this invention. In the case of using RDFS or OWL Full, the inventive concept may be implemented through the use of properties for keywords and description that decorate a class or individual that the ontology designer wishes to expose to the user interface. Such concepts may leverage rdfs:subclassOf property to implement the inheritance structure. In such a structure, there are number of benefits that can be achieved by having a simpler and more intuitive representation of concepts. All the semantic description of a concept can be present in the form as the properties used by the user interface, such that the user interface can seamlessly be integrated with a larger data model of an application at the ontology level.

The semantically marked up text may be in the form of an RDF document that describes the concept that the user has selected. One skilled in the art will appreciate that the above may be represented in a number of other formats that will be equivalent for the purposes of this invention including XML and others. Any key-value pair metadata scheme (e.g., s-expressions, XML, etc.) can be employed.

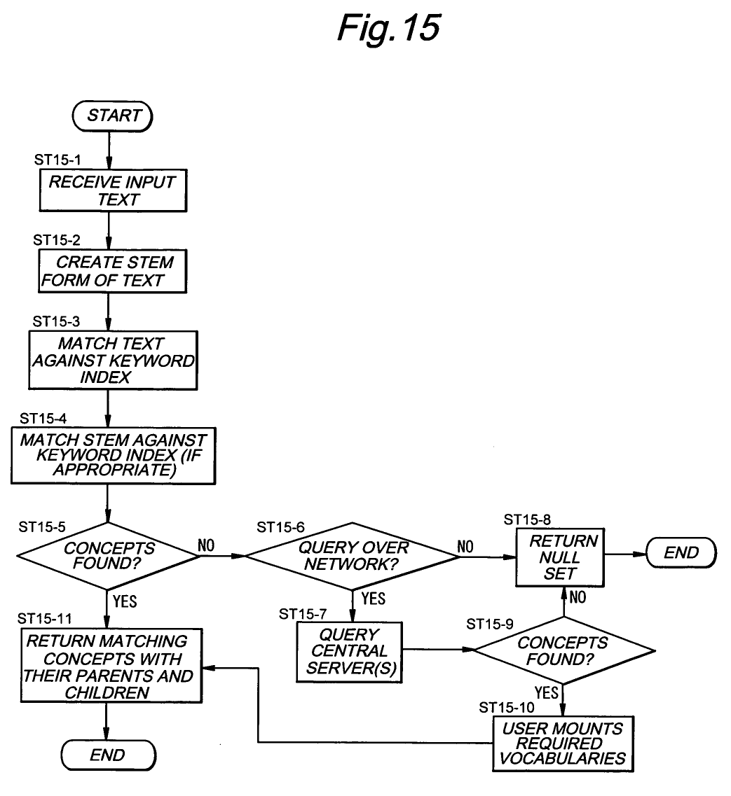

Referring to FIG. 15, in 15-1, the ontology engine receives the input text from the application. As noted before, this interface could be implemented as a simple function call, dll call, call of a component or an RPC depending on the implementation. This is one of two possible input/output interfaces for the ontology engine. This one accepts a input text and returns candidate concepts that match the input text. In 15-2, 15-3 and 15-4, the input text is matched against concepts stored within the ontology engine. Concepts are stored within vocabularies and it is likely that at least one such vocabulary is stored in the ontology engine. The ontology engine manages an index called the keyword index. The keyword index contains all the keywords of concepts that are defined within all the vocabularies stored within the ontology engine. For each keyword in the index, all concepts that have such a keyword are linked. This is a many-to-many relationship where a concept may have multiple keywords and a given keyword may correspond to multiple concepts. The input text is matched against the keywords in this index to find all keywords that match it. Since keywords may be from different natural languages, a technology like Unicode can be used to store the keywords. The matching process can be further limited to keywords corresponding to a given locale that the application specifies. The matching process can be based on complete or partial match of the entered text with the given keyword. In some character encodings, e.g. Unicode based encodings, there are some cases where two different character sequences look the same and are expected, by most users, to compare equal. An example is one using a pre-composed form (just one c-cedilla character) and another using a decomposed form (a ‘c’ character followed by a cedilla accent character). Early uniform normalization (to Unicode Normal Form C) may be used to perform the matching. Furthermore, the entered text may have morphological processing like stemming done at the ontology engine (depending upon the vocabulary and the locale) where words are converted to their root forms before matching against the index. The input string may be analyzed for each of its constituent words, to generate a so-called “stem” (or “base”) form. Stem forms are used in order to normalize differing word forms, e.g., verb tense and singular-plural noun variations, to a common morphological form for use by the ontology engine. Once the stem forms are produced, these are used to match against keywords present in the index. There are many concepts that are difficult to apply a stemming process to. A concept such as ‘Rights Amendment Bill’ may be inaccurate to stem. Such concepts can nevertheless be catered to through the use of a keyword that includes the complete text string. Furthermore, whether stemming is required may be set as an option at the vocabulary level, concept level as well as the keyword level. As may be noted, as long as the concepts have suitable keywords in a given natural language, support for that concept in that language is made possible in the user interface. Each keyword that is successful matched with the input text can be linked to multiple concepts. All such concepts are returned as candidates.

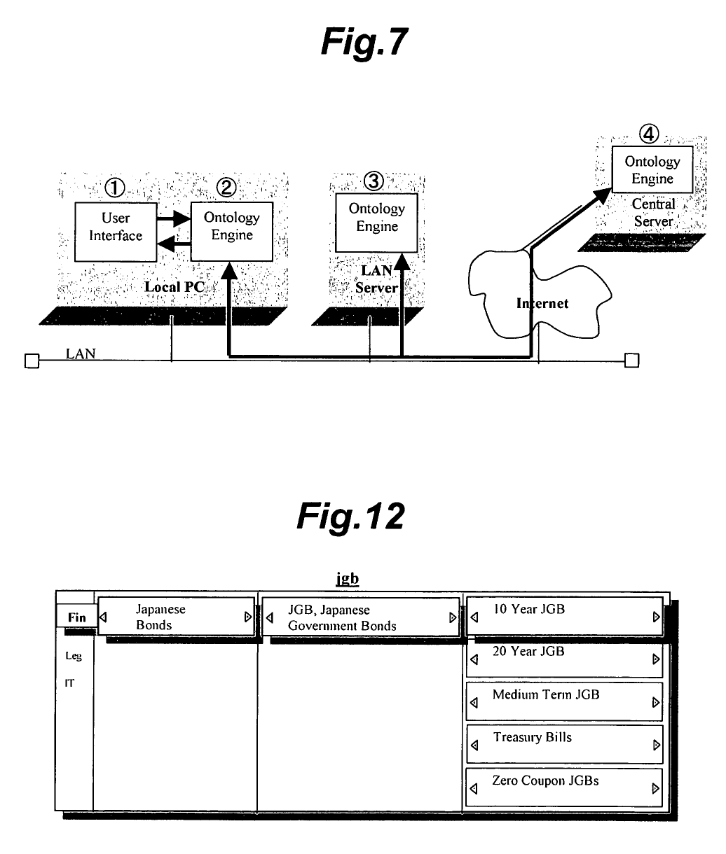

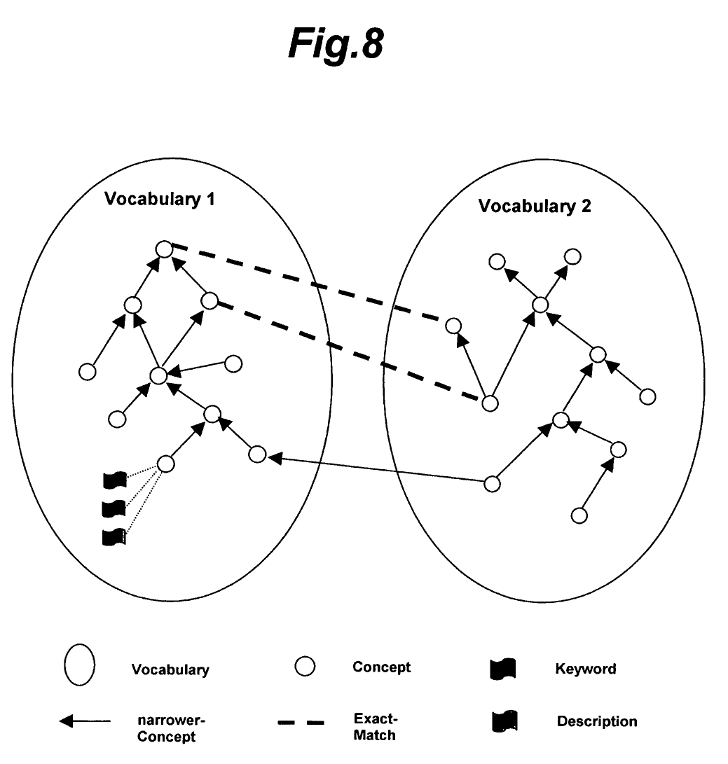

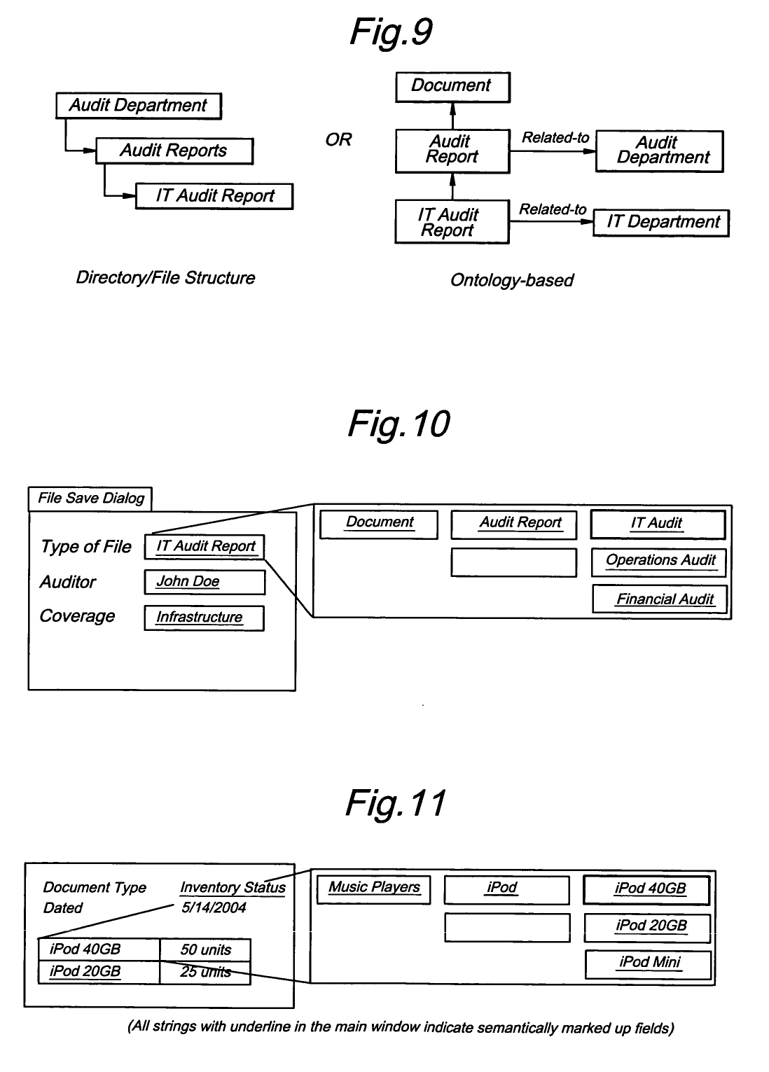

The ontology engine implements a storage for the vocabularies mounted within it. This may be implemented in form of a file, a database, or may be distributed across the network. It may also leverage modern file systems like the proposed WinFS file system in the upcoming release of Microsoft Windows to stores both concepts and relationships. In the case that the storage of the ontology engine is distributed over the network, there are number of methods for implementing it. Broadly, these may be client-server, master-cache, master-slave, peer-to-peer and other similar architectures. In a client-server architecture, the ontology engine may be resident on a server reachable through a network. The application or the human interface component could use varying RPC methods to query the ontology engine. This may be desirable if the client machine is a limited capability device such a cellular phone. Also, the ontology engine may operate in a master-cache fashion. In this case, the concepts of a vocabulary are not stored completely in one engine but are cached as per usage. In case a concept does not exist in the local storage, the ontology engine can query another engine on the network and so on until a master engine (which stores all concepts of that vocabulary) is reached as shown in FIG. 7. In this situation, the vocabularies mounted in the local ontology engines can each have a different master engine on the network or may be distributed across a network. This allows the incorporation of a LAN versus Internet style division, where the master ontology engine of a vocabulary relating to an organization may be resident on the LAN of the organization while the master of another vocabulary may be stored on the Internet. The LAN based ontology engine could also serve as a cache for the Internet based vocabulary while being the master for the LAN based vocabulary. The ontology engine may be architected in the form of a master-slave configuration so as to propagate information from a master server on the network to the local one. It may also be implemented in a P2P fashion such that concepts in a vocabulary may be stored in a distributed peer-to-peer fashion in either full or partial basis. The implementation of any such scheme is well understood in the state of art and the implementation details of these architectures are not covered here. However, regardless of the storage of a vocabulary in the ontology engine, for the purposes of this description the vocabulary is considered to be a collection of concepts that is complete. The network distribution of an ontology engine's storage is an implementation detail that may be made transparent to the interaction with the application. Therefore, for the purposes of this description, it is assumed that the entire vocabulary of concepts is present in the local ontology engine.

In 15-3 and 15-4, the matching is done against the vocabulary as a whole. However, irrespective of the above, the matching in 15-5 may not find a match against the keywords in the ontology engine. This implies that there is no vocabulary loaded in the ontology engine that has a concept that matches with the input text. This may be because there is no vocabulary loaded or that the right one in not loaded. If the user wishes to query over the network to discover such a vocabulary, then the user may select the corresponding option in the human interface, then processing progresses to 15-7. Otherwise a null set is returned.

The process of discovery at a central server can be implemented in a number of ways. A central server can warehouse vocabularies from a number of sources. It may be able to categorize or rank vocabularies on the basis of compatibility, extent of coverage of the keyword, depth of coverage of the concepts matched against the keywords, extent to which other vocabularies link to it through relations like exact-match or narrower-concept (a proxy for the popularity of the vocabulary), etc. The mechanism in 15-7 plays an important role in the management of such ontologies in a distributed and open-world architecture like the Internet. By allowing centralized management of vocabularies, there can be consistency checks that allow for the level of reliability and accuracy required for widespread use. Also, it allows the vocabularies to evolve in an organic manner. As it is unlikely that any ontology, not matter how large, will be able to be the one and only ontology required, it is a more practical method to start with a focused domain and increase upon based on use. The mechanism in 15-7 satisfies the basic requirement for such a growth.

A relevant vocabulary may be got by a user through the use of a download on a network or by getting the appropriate files on a CD or a floppy. This vocabulary is then mounted by the user in 15-10 and the entered text may now be matched against the index in the ontology engine and candidate concepts can be returned as in 15-11. The candidates may be returned individually or grouped with their parents and children, depending on the requirements of the user interface.

The ontology engine further provides another interface to applications where it accepts a concept instead of a keyword. This may be required in a situation where the ontology engine is servicing multiple applications. This interface basically serves as a reverse lookup for concepts. This interface can be divided into two kinds. One kind is where given a concept the ontology engine returns a corresponding keyword or description. The other kind is given a concept, the ontology engine returns a corresponding concept or concepts.

In the concept-to-keyword style of interface, the ontology engine may implement different kinds of functionality to cater to different application requirements. For example, given a concept the ontology engine could return the most frequently used keyword associated with the concept. Or given a concept, the ontology engine could return the description corresponding to that concept. Naturally, there may a number of permutations to this theme and the major ones are listed below. The listing below, concept is defined by the machine-readable ID, vocabulary and version corresponding to the concept:

given(concept) -> return(one of the keywords of the concept)

given(concept) -> return(the most frequently used keyword of that concept)

given(concept) -> return(the description of the concept)

given(concept, language) -> return(one of the keywords of the concept in that language)

given(concept, language) -> return(the most frequently used keyword in that language for that concept)

given(concept, language) -> return(the description of the concept in that language)

In the concept-to-concept style of interface, the application may require information about the structure of a vocabulary. As the only constraint put on the graph of concepts within the ontology engine is that it is a directed acyclic graph in terms of the narrower-concept relation after having factored in mapping through the exact-match relation, the kinds of information that can be reasonably queried is limited. This can include an application querying for the parents or the children of a particular concept in a particular vocabulary version. As an example, if an application does not understand or was not programmed to deal with a certain vocabulary, given a machine-readable ID from that vocabulary, it may need to have it mapped to a vocabulary that it understands. Such an application may query the ontology engine to get the corresponding exact-match concept in a vocabulary and version that it understands. If there is such a matching concept, the ontology engine can return it. This may be advantageously used in the case of upgrade or downgrade of vocabularies as well. In essence, an application expecting a newer vocabulary version could query the ontology engine to get a concept from an older version mapped to one in the newer version (presuming there is backward compatibility of concepts). Since it also quite likely that there will not be an exact mapping between every concept in two vocabularies or versions, more often the requirement for mapping may be reduced to getting a concept in a vocabulary that the application understands that is either a parent of the given concept or a child of the given concept. In a more general form, the application may request to get back a sub-graph of all paths from a given concept to a vocabulary or version that it understands or a sub-graph with the set of the shortest paths. Such sub-graphs may be computed by graph traversal and/or may be calculated by well-accepted algorithms such as Dijkstra's algorithm. Even this may not be sufficient for the needs of the application and future manual mapping may be required. However, in terms of an automated response to such application queries, the following may be a representative set of permutations on the possible interfaces that the ontology engine can offer.

given(concept) -> return(parent concepts)

given(concept) -> return(child concepts)

given(vocabulary, concept) -> return(parent concepts in that vocabulary)

given(vocabulary, concept) -> return(child concepts in that vocabulary)

given(vocabulary, version, concept) -> return(parent concepts in that vocabulary version)

given(vocabulary, version, concept) -> return(child concepts in that vocabulary version)

given(vocabulary1, concept1, vocabulary2) -> return(exact match for concept1 in vocabulary2)

given(vocabulary1, concept1, vocabulary2) -> return(shortest paths from the concept1 to vocabulary2)

given(vocabulary1, concept1, vocabulary2) -> return(all paths from the concept1 to vocabulary2)

given(vocabulary1, version1, concept1, vocabulary2) -> return(exact match for concept1 in vocabulary2)

given(vocabulary1, version1, concept1, vocabulary2) -> return(shortest paths from the concept1 to vocabulary2)

given(vocabulary1, version1, concept1, vocabulary2) -> return(all paths from the concept1 to vocabulary2)

given(vocabulary1, version1, concept1, vocabulary2, version2) -> return(exact match for concept1 in vocabulary2 version2)

given(vocabulary1, version1, concept1, vocabulary2, version2) -> return(shortest paths from the concept1 to vocabulary2 version2)

given(vocabulary1, version1, concept1, vocabulary2, version2) -> return(all paths from the concept1 to vocabulary2 version2)

The ontology engine allows the mounting and unmounting of disparate and arbitrary vocabularies of concepts. This is the key feature that allows this invention to scale from the narrow confines of a single applications dialog requirements to that of a semantic user interface across all applications. With the use of technologies such as RDF and OWL, the ontology engine can be made into an open-world system that allows dynamic incorporation of widely distributed knowledge Implementing concepts of vocabulary in RDF is easy because each Class, Instance, and relation is referred to through its URI reference, which serves as a globally unique ID. Vocabularies could be implemented as ontologies that have a distinct versioning system through the use of standard annotation properties. Two concepts in different vocabularies have distinct absolute identifiers (although they may have identical relative identifiers). The open-world nature of RDF allows ontologies to describe resources in other ontologies, thereby allowing for a very fine grain of integration. Since it is a standard, multiple ontologies can be made to work together in a seamless fashion without having to orchestrate their construction. As noted earlier, all these features may be implemented independent of RDF and semantic web technologies through the use of equivalent mechanisms. However, all this open-world characteristics makes the necessity for ontology merging, which is a difficult activity to do manually and almost impossible in an automated fashion.

The ontology engine, therefore, implements the bare minimum mechanism that are required for reliable operation of the user interface. Most of these mechanisms are implemented during the mount of an ontology so as to keep the internal graph of concepts consistent. A new vocabulary to be mounted on the ontology engine may be free standing, essentially not connected to any other ontology. This occurs when there is no overlap of concepts between the vocabulary and any others in the ontology engine.

Furthermore, there are no mapping relations (exact-match or narrower-concept) between concepts in the new vocabulary and any concept currently in any other vocabulary mounted in the ontology engine. The requirements for mounting such a vocabulary are simple, in that each concept must adhere to the definition of the concept in the ontology engine and that the graph formed by the concepts within the new vocabulary is a directed-acyclic graph with respect to the narrower-concept relation after adjusting for the exact-match relation. Such a vocabulary may be required for specialized concepts that are specific to an organization.

However, the more likely scenario is that the new vocabulary will offer specialized definitions of concepts that already exist in an existing vocabulary in the ontology engine. In order to ensure the consistency of all such vocabularies, the ontology engine keeps a central graph that is the sum of all vocabularies currently mounted on it. The mounting of any such new vocabulary is done by a process called mounting that ensures that all such mapping and requirements for consistency are maintained and that the new vocabulary becomes a part of the central index and graph. If the consistency checks fail, the vocabulary is not mounted.

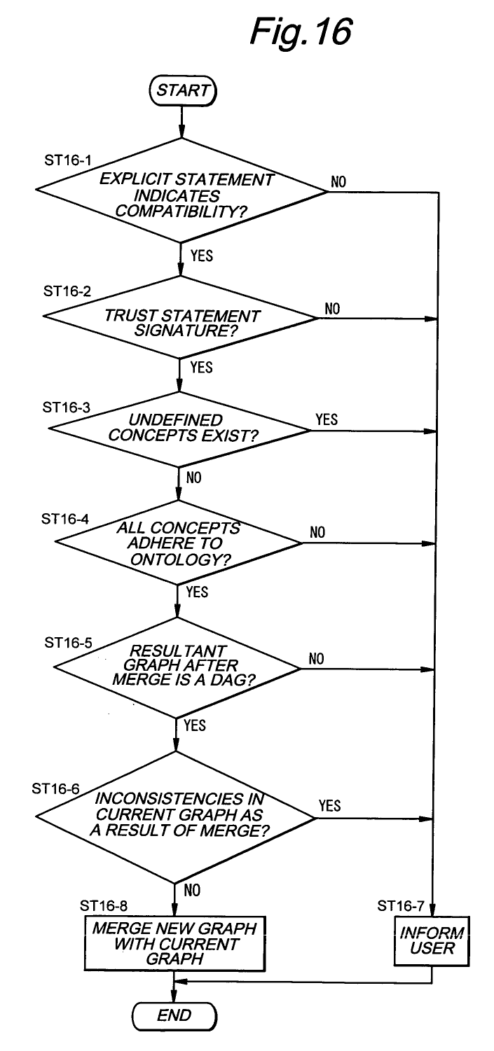

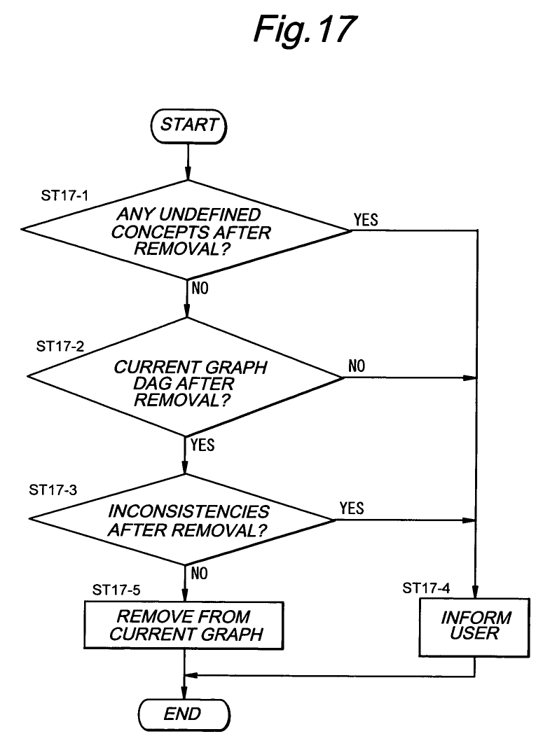

The flow chart for the mount process is shown in FIG. 16. A new vocabulary will essentially contain concepts that are internal to it, which do not need any external processing. It may also provide description about concepts external to it (as an example, a user vocabulary that provides alias keywords to an existing concept in another vocabulary) and mapping to concepts that are external to it. Therefore, it would affect a specific set of vocabularies and such a new vocabulary may make explicit statements of compatibility with respect to such vocabularies. In 16-1 and 16-2, the ontology engine checks if there is such an explicit statement of compatibility. If there is and the ontology engine trusts the digital signature of the statement, then ontology engine checks both the currently mounted vocabularies and version to see if such a vocabulary exists. If it doesn't it informs the user so that they can obtain the required vocabulary. If explicit statement of compatibility shows that the new vocabulary is not compatible with the existing vocabulary and version, the mount process informs the user and fails.

Even is there is no explicit statement of compatibility, the ontology engine may nevertheless attempt to mount the new vocabulary (depending on its implementation). In 16-3, the ontology engine checks if there are any concepts or relations that map to concepts, which are not present in the new vocabulary or the currently existing vocabularies in the ontology engine. If there are, essentially that means there are unresolved dependencies and the ontology engine may inform the user and optionally terminate processing of the mount until the required vocabularies are mounted. Although, the more conservative approach to consistency may require to terminate the mount, if it is not terminated then essentially the unresolved concepts would exist in a free-standing fashion in a vocabulary that is not mounted. In 16-4, if there are no unresolved dependencies, then the ontology engine checks whether each of the concepts, relationships and property-values conform to the ontology requirements for concepts (if there is description involving existing concepts, then these are checked as well). If it does not conform, then the ontology engine informs the user of such breaks and terminates the mounts. In 16-5, the ontology engine checks whether the resultant graph after all statements of the new vocabulary are added remains a directed-acyclic graph in terms of the narrower-concept relation after adjusting for the exact-match relation. If it does not, it informs the user of the inconsistency and terminates the mount operation. If concepts are added between an existing parent and child, then the transitive nature of the ‘narrower-Concept’ relationship is used. If a child has a new parent that is also the child of its previous parent, then the new narrower-Concept relationship subsumes the original one, as it is a transitive property. In 16-6, the ontology engine performs any other checks that the implementation may require to ensure consistency. As an example, an implementation may require that the main ontology referred to within an existing concept is the same one as the one referred to within a concept that is an exact-match to it in the new vocabulary. If all these consistency checks are cleared, the ontology engine now merges the new vocabulary into the existing graph (essentially doing an ontology merge). This has another major implication in a multiple application environment, where now the ontology engine's index is now the central lookup for all concepts within the system. These concepts are integrated and mapped, and therefore allow to be looked up in serendipitous ways that may not have been conceived by the designer of any single vocabulary or ontology.

In the case of a version upgrade, the changes introduced in the new version may be available as deltas to the existing vocabulary. These changes may include addition of new concepts, update of existing concepts, deprecation of existing concepts, addition of new ‘narrower-Concept’ or ‘exact-match’ relationship information, update of existing relationship information. In fashion similar to the mounting of new vocabularies, the ontology engine can check the existence of the previous version as well as its backward compatibility in 16-1. The ontology engine needs to ascertain that following any change the graph is still a Directed Acyclic Graph with respect to concepts and the ‘narrower-Concept’ relationship. Since it may not be possible to delete entries as they may be currently used in the system, the upgrade mechanism can include methods like deprecation that allows the use of deprecated concepts to be curtailed or removed. Also, in order to support some level of backward compatibility, equivalence to new concepts can be achieved through the exact match relationship as noted in the previous section of the application interface to the ontology engine for querying concepts.

It is important to note that all the description in this section refers to the ontology requirements of the concepts, properties and relationships used in the vocabularies refer to the user interface only. As each concept can have semantic description much richer than that required by the user interface, the requirements for the ontology engine do not specifically refer to such descriptions. It can be expected that such descriptions will be handled in the context of a more general ontology store.

Unmounting may proceed in a manner that is the reverse of mounting. Referring to FIG. 17, in 17-1, the ontology engine checks if after the unmounting, there will be any concepts, relationships, etc. that are unresolved. Essentially, if there is a vocabulary that is dependent on the vocabulary to be unmounted. If there is, it can inform the user and terminate the processing until the other vocabulary is unmounted first. Explicit dependency information between vocabularies with optional digital signatures may also be used for this check. In 17-2, the ontology engine check whether the unmount operation leaves the central graph as a DAG. If not, it does not proceed. In 17-3, the ontology engine may further check whether any of the concepts from this ontology are used in the system and prompting the user if there are. In 17-4, after all the checks have been passed, the unmount operation completely removes all statements in the vocabulary from the system and making them unavailable for future processing. The unmount operation can be used with version upgrades as well following the same principles.

In the case of unmounting of vocabularies, the processing may be somewhat different. Depending on the implementation of the ontology engine it may be desirable to have a base vocabulary that cannot be unmounted although its version upgrades might be unmounted. Also, depending on the implementation requirements, if a vocabulary that is required to mount a new vocabulary, or a version upgrade, is not found in the ontology, then the engine may optionally proceed to discover such a vocabulary or version by querying the central server. Through a mechanism such as this, dependency information between vocabularies may be explicitly declared and managed.

It likely that in the initial days of the Semantic Web, there will be a large number of situations where a suitable vocabulary cannot be found for the purpose at hand. In that case, the user interface gracefully degenerates into one that is a text keyword as is present in the web today. Furthermore, vocabularies do not necessarily need to implement graph structures or lexical inheritance. For a small vocabulary with no structure, the user interface gracefully degenerates into a drop down menu. While a considerable amount of the user interface metaphor's richness comes from GUI interaction, it may also be implemented in a voice based interface where semantic disambiguation can proceed in the lines of questions clarifying the meaning through the selection of appropriate choices. Similar parallels may be drawn to interfaces based on sign-language, Braille, etc. Similarly, the input method for text has been assumed to be a keyboard, but it can be achieved through hand-writing recognition, voice recognition in a voice dialog system, etc. A practitioner in the field will notice that this invention is not limited to personal computers but can also be made available to a large number of other devices, including but not limited to PDA's, cellular phones, GPS systems, consumer electronics, etc. without changing the spirit or the purpose of the invention.

Although the present invention has been described in terms of preferred embodiments thereof, it is obvious to a person skilled in the art that various alterations and modifications are possible without departing from the scope of the present invention which is set forth in the appended claims.

1. An ontology engine, comprising:
a storage holding a vocabulary, the vocabulary including a plurality of machine-readable IDs each corresponding to a concept and at least one keyword corresponding to each machine-readable ID;
an input interface unit that accepts text information, selects those machine-readable IDs whose keywords match up with the text information, and returns a list of candidates each corresponding to one of the selected machine-readable IDs and including a corresponding description;
a human interface unit that allows a user to select one of the candidates; and
an output interface unit that returns one of the machine-readable IDs corresponding to the candidate selected at the human interface.

2. The ontology engine according to the claim 1, wherein the input interface unit is adapted to accept text information from a member selected from a group consisting of a user input device, a computer application and a computer operating system.

3. The ontology engine according to claim 1, wherein each machine-readable ID is defined as a unique ID within the engine.

4. The ontology engine according to claim 1, wherein each machine-readable ID is defined as a globally unique ID.

5. The ontology engine according to claim 1, wherein the storage includes a plurality of discrete storages that are distributed within a network system.

6. The ontology engine according to claim 5, wherein the discrete storages are distributed within a network system in at least one of a member of a group of configurations consisting of a master-slave configuration, a master-cache configuration, a client-server configuration and a peer-to-peer configuration.

7. The ontology engine according to claim 5, wherein the network consists of the Internet.

8. The ontology engine according to claim 1, wherein the user interface is adapted to have the candidates ordered in the list according to frequency of past selection.

9. The ontology engine according to claim 1, wherein each machine-readable ID is associated with a plurality of keywords in different languages.

10. The ontology engine according to claim 1, wherein the input interface unit, human interface unit and output interface unit are incorporated in a computer operating system and mark up the text information with the returned machine-readable ID for delivery to an external application.

11. The ontology engine according to claim 1, wherein the description of each candidate is selected from the at least one of the corresponding keywords.

12. The ontology engine according to claim 1, wherein the concepts are linked to each other on the basis of a relationship selected from a group of relationships consisting of a narrower-meaning relationship, an exact match relationship and a no relationship.

13. The ontology engine according to claim 12, wherein the graph formed by the narrower-meaning relationship is a Directed Acyclic Graph over all the concepts within the vocabulary.

14. The ontology engine according to claim 12, wherein the list of candidates are given with a tree structure based on the narrower-meaning relationship.

15. The ontology engine according to claim 12, wherein the human interface is adapted to allow a user to navigate and select among narrower and broader concepts.

16. The ontology engine according to claim 1, wherein the output interface unit returns the machine-readable ID by tagging the machine-readable ID to a corresponding part of the text information.

17. The ontology engine according to claim 1, wherein the ontology engine includes a plurality of discrete vocabularies that can be selectively mounted and dismounted.

18. The ontology engine according to claim 17, wherein the vocabularies can be selectively upgraded and downgraded.

19. The ontology engine according to claim 17, wherein each candidate is marked so as to identify which of the discrete vocabularies the candidate has come from.

20. The ontology engine according to claim 17, wherein the keywords are matched up with the text information after stemming the text information.

21. An ontology engine, comprising:
a storage holding a vocabulary, the vocabulary including a plurality of machine-readable IDs each corresponding to a concept and at least one keyword corresponding to each machine-readable ID;
an input interface unit that accepts a machine-readable ID; and
an output interface unit that returns at least one of the keywords corresponding to each accepted machine-readable ID.

22. The ontology engine according to claim 21, wherein each of at least some of the machine-readable IDs corresponds to a plurality of keywords, and the output interface unit returns one of such plurality of keywords according to past usage and/or context.

23. The ontology engine according to claim 21, further comprising a search engine that searches a machine-readable ID in at least one member selected from a group consisting of files, web sites and databases, passes on a searched machine ID to the input interface, and receives one of the keywords corresponding to the searched machine-readable ID.

24. The ontology engine according to claim 21, wherein each machine-readable ID is associated with a plurality of keywords in different languages, the engine further comprising a language switch for selecting one of the languages so that the output interface unit returns a keyword of that selected language corresponding to each accepted machine-readable ID.

25. The ontology engine according to claim 24, wherein each of at least some of the machine-readable IDs corresponds to a plurality of keywords in at least one of the languages, and the output interface unit returns one of such plurality of keywords according to past usage and/or context.

26. A ontology engine, comprising:
a storage holding a vocabulary, the vocabulary including a plurality of machine-readable IDs each corresponding to a concept and at least one keyword corresponding to each machine-readable ID, the concepts being at least partly linked to each other on the basis of a parent-child relationship;
an input interface unit that accepts a machine-readable ID; and
an output interface unit that returns another machine-readable ID corresponding to a concept that is a parent or child to the concept corresponding to each accepted machine-readable ID.

27. The ontology engine according to claim 26, wherein at least some of the concepts are linked to one another in a one to plural parent-child relationship, and the output interface unit returns two or more concepts that are parents or children to the concept corresponding to each accepted machine-readable ID when such a one to plural parent-child relationship exists.

28. The ontology engine according to claim 26, wherein the concept corresponding to the machine-readable ID that is returned by the output interface unit is related to the concept corresponding to each accepted machine-readable ID on the basis of an exact match relationship, narrower-concept relationship and/or a shortest path relationship.

29. A ontology engine, comprising:
a storage holding a plurality of discrete vocabularies, each vocabulary including a plurality of machine-readable IDs each corresponding to a concept and at least one keyword corresponding to each machine-readable ID, at least some of the concepts in the different vocabularies being linked to each other on the basis of a prescribed relationship;
an input interface unit that accepts a machine-readable ID from a first one of the discrete vocabularies; and
an output interface unit that returns another machine-readable ID corresponding to a concept belonging to a second one of the discrete vocabularies that is related to the concept corresponding to each accepted machine-readable ID.

30. An input method for semantically tagging entered text information, comprising:
mounting a vocabulary that includes a plurality of machine-readable IDs each corresponding to a concept and at least one keyword corresponding to each machine-readable ID;
entering text information;
matching the entered text information with the keywords that are held in the vocabulary and returning a list of candidates each corresponding to one of the selected machine-readable IDs and including a corresponding description;
allowing selection of one of the candidates; and
returning the machine-readable ID corresponding to the selected candidate.

31. An output method for disambiguating text information by detecting a tag attached to the text information, comprising:
mounting a vocabulary that holds a plurality of machine-readable IDs each corresponding to a concept and at least one keyword corresponding to each machine-readable ID;
extracting a machine-readable ID from text information; and
returning at least one of the keywords corresponding to the extracted machine-readable ID by looking up the vocabulary.

32. The output method according to claim 31, wherein a machine readable ID is extracted from text information that is searched from at least one member selected from a group consisting of files, web sites and databases.

33. A file save method using an ontology engine, comprising:
mounting a vocabulary that holds a plurality of machine-readable IDs each corresponding to a concept and at least one keyword corresponding to each machine-readable ID;
providing a file save dialog that allows text information describing the file to be entered;
matching the text information with the keywords in the vocabulary and extracting corresponding machine-readable IDs from the vocabulary;
listing candidates each corresponding to one of the selected machine-readable IDs and including a corresponding description;
allowing a user to select one of the candidates; and
tagging the file with the machine-readable ID corresponding to the selected candidate before saving the file.

34. A file save method using an ontology engine, comprising:
mounting a vocabulary that holds a plurality of machine-readable IDs each corresponding to a concept and at least one keyword corresponding to each machine-readable ID;
providing a file save dialog that indicates a directory in which a file is going to be saved and allows text information describing the file to be entered;
matching the text information with the keywords in the vocabulary and extracting corresponding machine-readable IDs from the vocabulary;
listing candidates each corresponding to one of the selected machine-readable IDs and including a corresponding description;
allowing a user to select one of the candidates; and
tagging the file with the machine-readable ID corresponding to the selected candidate before saving the file.

35. A method of allocating a file that is tagged with a machine-readable ID corresponding to a concept to a virtual directory according to the concept by using an ontology engine, comprising:
creating a plurality of virtual directories each represented by a concept; and
allocating a file to at least one of the virtual directories according to a machine-readable ID that is tagged to the file and matches the concept represented by the at least one of the virtual directories.

36. The method according to claim 35, wherein the matching of the concepts of the directories with those corresponding to the machine-readable IDs that are tagged to the files are based on a member selected from a group consisting of an exact match relationship and a parent-child relationship.

37. The method according claim 36, wherein the matching of the concepts of the directories with those corresponding to the machine-readable IDs that are tagged to the files is based on a parent-child relationship where all concepts of the directories are ancestors of the IDs tagged to the files.

38. The method according to claim 35, wherein at least some of the concepts are related to each other by a non-exact match relationship, and the matching of the concepts of the directories with those corresponding to the machine-readable IDs that are tagged to the files are at least partly based on the non-exact match relationship.

39. The method according to claim 38, wherein concepts are also related to each other on the basis of a parent-child relationship, and the matching of the concepts of the directories with those corresponding to the machine-readable IDs that are tagged to the files are at least partly based on the non-exact match relationship to the ancestors of the machine-readable ID.

40. A file search method using an ontology engine, comprising:
mounting a vocabulary that holds a plurality of machine-readable IDs each corresponding to a concept and at least one keyword corresponding to each machine-readable ID;
entering text information that describes a desired file;
matching the text information with the keywords in the vocabulary and extracting corresponding machine-readable IDs from the vocabulary;
listing candidates each corresponding to one of the selected machine-readable IDs and including a corresponding description;
allowing a user to select one of the candidates; and
searching a file that is tagged with a machine-readable ID corresponding to the selected candidate.

41. The file search method according to claim 40, further comprising searching a file that is tagged with another machine-readable ID which is related to the machine-readable ID corresponding to the selected candidate in terms of the corresponding concepts in a prescribed relationship.

42. The file search method according to claim 41, wherein the prescribed relationship is a member selected from at least one of a group consisting of exact-match, parent-child and non-exact-match.

43. The file search method according to claim 42, wherein the descendents of the input machine-readable ID are matched with the machine-readable ID tagged with the file.

44. The file search method according to claim 42, wherein input machine-readable ID is matched with concepts that are related to the machine-readable ID in the tagged file through a non-exact match relationship.

45. The file search method according to claim 44, wherein the input machine-readable ID is matched with concepts that are related to the ancestors of the machine-readable ID in the tagged file through a non-exact match relationship.

46. The file search method according to claim 41, wherein the search is done on the basis of a criterion specified in a query language.

47. The file search method according to claim 41, wherein the search is done on the basis of rules.

48. A method of accepting a command in application software, comprising:
mounting a vocabulary that holds a plurality of machine-readable IDs each corresponding to a command for the application software and at least one keyword corresponding to each command;
entering text information that describes a desired command;
matching the text information with the keywords in the vocabulary and extracting corresponding commands from the vocabulary;
listing candidates each corresponding to one of the extracted commands and including a corresponding description;
allowing a user to select one of the candidates; and
forwarding a command that corresponds to the selected candidate for execution in the application software.

49. The method of accepting a command in application software according to claim 48, wherein the entering of text is done through voice recognition.

50. The method of accepting a command in application software according to claim 48, wherein the input parameters of the command is entered through the same input method.

51. A method of embedding a machine-readable ID along with text information in a document so as to serve as a command in an application software, comprising:
mounting a vocabulary that holds a plurality of machine-readable IDs each corresponding to certain specific data for the application software and at least one keyword corresponding to each specific data;
entering text information that describes desired command;
matching the text information with the keywords in the vocabulary and extracting a corresponding machine-readable ID from the vocabulary; and
forwarding the extracted machine-readable ID to be stored in the document.

52. A method of embedding a machine-readable ID along with text information in a document so as to serve as input data for a command in an application software, comprising:
mounting a vocabulary that holds a plurality of machine-readable IDs each corresponding to certain specific data for the application software and at least one keyword corresponding to each specific data;
entering text information that describes desired data;
matching the text information with the keywords in the vocabulary and extracting a corresponding machine-readable ID from the vocabulary; and
forwarding the extracted machine-readable ID to be stored in the document.

53. A method of publishing a plurality of messages so as to selectively deliver the messages to each of a plurality of subscribers by taking into account a predetermined preference of the subscriber, comprising:
mounting a vocabulary that holds a plurality of machine-readable IDs each corresponding to a concept and at least one keyword corresponding to each machine-readable ID;
allowing each subscriber to enter text information that represents a preference of the subscriber;
assigning at least one of the machine-readable IDs to the subscriber that is extracted from the vocabulary by matching the entered text information with the keywords;
assigning at least one machine-readable ID to each published message according to a concept that represents contents and/or attributes of the message;
finding matches between the machine-readable IDs assigned to the subscribers and the machine-readable IDs assigned to the messages; and
delivering each message only to those subscribers whose machine-readable ID matches with the machine-readable ID of the message.

54. The method according to claim 53, wherein the step of assigning at least one of the machine-readable IDs to the subscriber that is extracted from the vocabulary by matching the entered text information with the keywords is performed by using an input interface unit that accepts text information, selects those machine-readable IDs whose keywords match up with the text information, and returns a list of candidates each corresponding to one of the selected machine-readable IDs and including a corresponding description.

55. The method according to claim 53, wherein the step of assigning at least one machine-readable ID to each published message according to a concept that represents contents and/or attributes of the message is performed by using an input interface unit that accepts text information, selects those machine-readable IDs whose keywords match up with the text information, and returns a list of candidates each corresponding to one of the selected machine-readable IDs and including a corresponding description.

56. The method according to claim 53, wherein a machine-readable ID assigned to a message matches with a machine-readable ID assigned to a subscriber, when the message machine-readable ID is related to the subscriber machine-readable ID through relationships selected from a group consisting of an exact match, child and descendant relationship.

57. The method according to claim 53, wherein a plurality of machine-readable IDs are assigned to at least to some of the subscribers, and the machine-readable IDs of such a subscriber are matched with those of the messages according to a combination of logical expressions.

58. A method according to claim 53, wherein a plurality of machine-readable IDs are assigned to at least to some of the subscribers, and the machine-readable IDs of such a subscriber are matched with those of the messages according to rules.
